(19) United States
(12) Patent Application Publication
(10) Pub. No.: US 2025/0105632 A1
(43) Pub. Date: Mar. 27, 2025

(54) DAY-AHEAD SCHEDULING METHOD AND APPARATUS FOR POWER SYSTEM, ELECTRONIC DEVICE AND STORAGE MEDIUM

(71) Applicant: Tsinghua University, Beijing (CN)

(72) Inventors: Feng LIU, Beijing (CN); Kai KANG, Beijing (CN); Ning QI, Beijing (CN); Yifan SU, Beijing (CN)

(73) Assignee: Tsinghua University, Beijing (CN)

(21) Appl. No.: 18/590,757

(22) Filed: Feb. 28, 2024

(30) Foreign Application Priority Data
Sep. 22, 2023 (CN) 2023112347322

(51) Int. Cl. H02J 3/46; H02J 3/00; H02J 3/16

(52) U.S. Cl. CPC H02J 3/466; H02J 3/004; H02J 3/16; H02J 2203/10; H02J 2300/24; H02J 2310/00

(57) ABSTRACT

The present application provides a day-ahead scheduling method and apparatus for a power system, an electronic device, and a storage medium, where the method includes: obtaining power system prediction parameters in a to-be-scheduled time period, where the power system prediction parameters include thermal power unit parameters, renewable energy station parameters, load parameters, energy storage station (ESS) parameters, node parameters, a transmission line parameter and other power gird parameters; constructing a day-ahead scheduling optimization model and generating multiple renewable energy power scenarios based on the power system prediction parameters; solving the day-ahead scheduling optimization model to obtain day-ahead scheduling results; verifying the day-ahead scheduling results based on the power system prediction parameters and the multiple renewable energy power scenarios; and in case that the verifying the day-ahead scheduling results successes, outputting the day-ahead scheduling results. In the method, the impact of the renewable energy station grid-connected proportion instructions on the renewable energy power scenarios is characterized by generating multiple renewable energy power scenarios, the voltage security for nodes in the power system is ensured by constructing the day-ahead scheduling optimization model, the feasibility of intraday power grid operation is ensured by verifying the day-ahead scheduling result, and the power system is safely and economically scheduled under the condition of voltage security.

### FIELD

The present application relates to the field of power system scheduling and operation, and in particular to a day-ahead scheduling method and apparatus for a power system, an electronic device, and a storage medium.

### BACKGROUND

In recent years, global investment in renewable energy sources represented by wind power and photovoltaics has continuously increased, and renewable energy sources have developed rapidly.

For solar photovoltaic technology, with the continuous improvement of solar panel efficiency, the cost of unit solar power generation is gradually decreasing, and the scale of solar power generation continues to expand; for wind power generation, the installed capacity of wind turbines is growing rapidly, wind power generation technology continues to improve, and the efficiency and reliability of wind power generation technology continues to be enhanced.

However, the uncertainty of renewable energy sources brings significant challenges to the supply-demand security of the power system:
on one hand, in the context of a high penetration of renewable energy power system, the decision instructions from a scheduling center to a renewable energy station affect the inherent uncertainty of the renewable energy station, which is a decision-dependent uncertainty;
on the other hand, with the gradual withdrawal of conventional thermal power units and diversified development of loads, the problem of reactive balance in the high-penetration renewable energy power system receives widespread attention, and focus needs to be brought on how to ensure reasonable scheduling of reactive resources while operating with the gradual withdrawal of thermal power units, and thus ensuring the voltage security of the power system.

That is, in the context of a high penetration of renewable energy power system, the decision-dependent uncertainty for renewable energy and the voltage security of power system needs to be fully considered in the active power spare scheduling decision, the renewable energy grid-connected proportion instruction decision, and the demand-side response capacity decision of the power system, thereby ensuring safe and economic scheduling of the power system under the condition of voltage security.

In order to deal with the uncertainty in the power system, the prior art provides a two-stage robust spare tuning mode. Specifically, the uncertainty of renewable energy is modeled as uncertainty sets, and in the mainstream research, the uncertainty sets of the power system are not affected by the decision instructions.

However, in a high-penetration renewable energy power system, scheduling instructions represented by grid-connected proportion instructions and output upper limit instructions of renewable energy stations affect the uncertainty range of the power system, and renewable energy output characterized by the uncertainty sets in which the affection of the decision instructions are not considered deviates from the actual power system, which has an adverse impact on the economics and feasibility of the operation of the high-penetration renewable energy power system.

In addition, the premise of the two-stage robust spare tuning mode is that the unit spare reserve value for all time periods is calculated after the uncertainty for all time periods is known. However, in the actual operation of the power system, the scheduling center cannot accurately obtain the renewable energy output for all future time periods.

That is, the spare tuning result obtained by the two-stage robust spare tuning mode may lead to infeasible intraday actual scheduling. The multi-stage scheduling process of the power system needs to be appropriately characterized to suppress the adverse impact on scheduling feasibility caused by the two-stage scheduling premise in the two-stage robust spare tuning mode.

It should also be noted that the power flow equation of the power system is a typical nonlinear form. However, in traditional power system scheduling optimization, direct current (DC) power flow is generally used as a modeling manner of network power flow. The DC power flow has the characteristics of a small calculation amount and fast solution, but cannot characterize the reactive power transmission process of the power system.

That is, in the context of the gradual withdrawal of thermal power units with reactive power regulating capabilities in high-penetration renewable energy power systems, the widely used power system power flow modeling manner of DC power flow cannot effectively characterize the reactive power flow of the power system, which has a potential adverse impact on the voltage security of the power system.

Therefore, the problem that the decision-dependent uncertainty of the renewable energy system and the voltage security of power system are not fully considered in traditional power system scheduling modes is an important issue that needs to be solved urgently in the field of power system scheduling and operation technology.

### SUMMARY

The present application provides a day-ahead scheduling method and apparatus for a power system, an electronic device, and a storage medium, to solve the problem that the decision-dependent uncertainty for renewable energy and the voltage security of power system are not fully considered in traditional power system scheduling modes, thereby ensuring safe and economic scheduling of the power system under the condition of voltage security.

The present application provides a day-ahead scheduling method for a power system, including:
obtaining power system prediction parameters in a to-be-scheduled time period, where the power system prediction parameters include thermal power unit parameters, renewable energy station parameters, load parameters, energy storage station (ESS) parameters, node parameters, a transmission line parameter and other power gird parameters;
constructing a day-ahead scheduling optimization model and generating multiple renewable energy power scenarios based on the power system prediction parameters;
solving the day-ahead scheduling optimization model to obtain day-ahead scheduling results;
verifying the day-ahead scheduling results based on the power system prediction parameters and the multiple renewable energy power scenarios; and
in case that verifying the day-ahead scheduling results successes, outputting the day-ahead scheduling results.

Further, constructing the day-ahead scheduling optimization model based on the power system prediction parameters includes:

constructing an objective function for power system day-ahead scheduling optimization problem and objective constraints corresponding to the objective function based on the power system prediction parameters.

Further, the objective function for power system day-ahead scheduling optimization problem is as follows:

$$\{ {c}_{i}^{g} {p}_{i}^{g} ( t ) + {c}_{i}^{spare} [ {r}_{i}^{g , up} ( t ) + {r}_{i}^{g , dn} ( t ) ] \} + {min}_{\begin{matrix}{p}_{i}^{g} ( t ) , {r}_{i}^{g , up} ( t ) , {r}_{i}^{g , dn} ( t ) , {w}_{j}^{pption} ( t ) , {p}_{d}^{dr} ( t ) , \\ {p}_{j , y}^{re , cut} ( t ) , {p}_{j , y}^{re} ( t ) , {p}_{d , y}^{load} ( t ) , {p}_{d , y}^{load , cut} ( t ) , {p}_{i , y}^{gc} ( t ) , {q}_{i , y}^{gc} ( t ) , \\ {p}_{k , y}^{e , ch} ( t ) , {p}_{k , y}^{e , dc} ( t ) , {E}_{k , y} ( t ) , {q}_{k , y}^{e} ( t ) , {p}_{l , y}^{brch} ( t ) , {q}_{l , y}^{brch} ( t ) , \\ {s}_{y}^{1} ( t ) ∼ {s}_{y}^{4} ( t ) , {s}_{y}^{5} ( t ) ∼ {s}_{y}^{12} ( t ) , {v}_{b , y}^{amp} ( t ) , {p}_{b , y}^{bus} ( t ) , {q}_{b , y}^{bus} ( t ) , {θ}_{b , y} ( t ) , \\ {r}_{i , y}^{gc , use} ( t ) , {q}_{i , y}^{gc , use} ( t ) , {q}_{k , y}^{e , use} ( t ) , {η}_{y} , ∀ d , i , j , k , t , y = 1 , ... , \vert {Y}_{n}^{} \vert\end{matrix}} {\sum }_{t ∈ 𝒯} {\sum }_{j ∈ {R}_{}} {c}_{j}^{pption} \cdot \frac{{\overline{W}}_{j}^{pption} - {w}_{j}^{pption} ( t )}{{\overline{W}}_{j}^{pption} - {\underline{W}}_{j}^{pption}} + {\sum }_{t ∈ 𝒯} {\sum }_{d ∈ {D}_{}} {c}_{d}^{dr} {p}_{d}^{dr} ( t ) + {\sum }_{y ∈ {Y}_{n}^{}} {η}_{y}$$

$$s . t . objective constraints$$

where [symbol] is a set of scheduling time periods, [symbol] _{G} is a set of thermal power units, cᵢ^{g} is a cost per unit power output, pᵢ^{g}(t) is active pre-output power of a thermal power unit i in a time period t, cᵢ^{spare} is a regulation spare cost for regulating up and down per unit, rᵢ^{g,up}(t) is an uphill capacity of the thermal power unit i in the time period t, rᵢ^{g,dn}(t) is a downhill capacity of the thermal power unit i in the time period t, wⱼ^{pption}(t) is a renewable energy station grid-connected proportion of a renewable energy station j in the time period t, p_{d}^{dr}(t) is a protocol capacity of a demand side response of a load d in the time period t, p_{j,y}^{re,cut}(t) is a renewable energy power reduction value of the renewable energy station j in the time period t, p_{j,y}^{re}(t) is a renewable energy power grid-connected value of the renewable energy station j in the time period t, p_{d,y}^{load}(t) is a load power supply value of the load d in the time period t, p_{d,y}^{load,cut}(t) is a demand side response usage value of the load d in the time period t, p_{i,y}^{gc}(t) is unit real-time active power output of the thermal power unit i in the time period t, q_{i,y}^{gc}(t) is unit real-time reactive power output of the thermal power unit i in the time period t, p_{k,y}^{e,ch}(t) is active charging power of an energy storage station k in a scenario y and the time period t, p_{k,y}^{e,dc}(t) is active discharging power of the energy storage station k in the scenario y and the time period t, E_{k,y}(t) is stored energy of the energy storage station k in the scenario y and the time period t, q_{k,y}^{e}(t) is reactive power injected by the energy storage station to the power grid, p_{l,y}^{brch}(t) is active power flow of a transmission line l in the scenario y and the time period t, q_{l,y}^{brch}(t) is reactive power flow of the transmission line l in the scenario y and the time period t, s_{y}¹(t)˜s_{y}²(t) are slack variables of active power balance in the power system, s_{y}³(t)˜s_{y}⁴(t) are slack variables of reactive power balance in the power system, s_{y}⁵(t)˜s_{y}¹² (t) are line capacity slack variables considering active power flow and reactive power flow, v_{b,y}^{amp}(t) is a node voltage of a node b in the scenario y and the time period t, p_{b,y}^{bus}(t) is an active power input value of the node b in the scenario y and the time period t, q_{b,y}^{bus}(t) is a reactive power input value of the node b in the scenario y and the time period t, θ_{b,y}(t) is a node phase angle value of the node b in the scenario y and the time period t, r_{i,y}^{gc,use}(t) is an auxiliary variable for obtaining the active power spare usage amount, q_{i,y}^{gc,use}(t) is an auxiliary variable for obtaining the reactive power spare usage amount, q_{k,y}^{e,use}(t) is an auxiliary variable for obtaining the reactive power spare usage amount of the energy storage station, [symbol] _{R} is a set of the renewable energy stations, cⱼ^{pption} is a unit cost of the renewable energy station grid-connected proportion regulation instruction, W̅ⱼ^{pption} is a upper limit of the renewable energy station grid-connected proportion of the renewable energy station j in the time period t, W̅ⱼ^{pption} is a lower limit of the renewable energy station grid-connected proportion of the renewable energy station j in the time period t, [symbol] _{D} is a set of the loads, c_{d}^{dr} is a cost of the demand side response per unit capacity, [symbol] _{Y}ⁿ is a set of typical renewable energy scenarios, η_{y} is a variable of power system operating cost in the scenario y, d is an index of the loads, i is a thermal power unit number, j is an index of the renewable energy stations, k is an index of the energy storage stations, t is a scheduling time point, y is an index of the renewable energy scenarios, l is an index of the transmission lines, and | [symbol] _{Y}ⁿ| is a number of elements included in the set of typical renewable energy scenarios [symbol] _{Y}ⁿ.

Further, the objective constraints include voltage security constraints, and the voltage security constraints include:
a constraint of node voltage amplitude:

$${\underline{V}}_{b}^{amp} \leq {v}_{b , y}^{amp} ( t ) \leq {\overline{V}}_{b}^{amp} , ∀ t ∈ , y = 1 , … , \vert {Y}_{n}^{} \vert , ∀ b ∈ ,$$

where V_{b}^{amp} amp and V̅_{b}^{amp} are a lower limit and an upper limit of the node b in the scenario y and the time period t respectively, b is an index of the nodes, and [symbol] is a set of the nodes;
a constraint of node active power:

$${p}_{b , y}^{bus} ( t ) = - {BF}_{b , d}^{D} \cdot {p}_{d , y}^{load} ( t ) + {BF}_{b , i}^{G} \cdot {p}_{i , y}^{gc} ( t ) + {BF}_{b , j}^{R} \cdot {p}_{j , y}^{re} ( t ) + {BF}_{b , k}^{ESS} \cdot [ - {p}_{k , y}^{e , ch} ( t ) + {p}_{k , y}^{e , dc} ( t ) ] ,$$

$$∀ b , d , i , j , k , l , t , y = 1 , … , \vert {Y}_{n}^{} \vert ,$$

where BF_{b,d}^{D} is a position correlation matrix of the load d with respect to the node b, BF_{b,i}^{G} is a position correlation matrix of the thermal power unit i with respect to the node b, BF_{b,j}^{R} is a position correlation matrix of the renewable energy station j with respect to the node b, BF_{b,k}^{ESS} is a position correlation matrix of the energy storage station k with respect to the node b;
a constraint of node reactive power:

$${q}_{b , y}^{bus} ( t ) = - {BF}_{b , d}^{D} \cdot {Q}_{d , t}^{D} + {BF}_{b , i}^{G} \cdot {q}_{i , y}^{gc} ( t ) + {BF}_{b , k}^{ESS} \cdot {q}_{k , y}^{e} ( t ) ,$$

$$∀ b , d , i , j , k , l , t , y = 1 , … , \vert {Y}_{n}^{} \vert ,$$

where Q_{d,t}^{D} is a reactive power demand of the load d in the time period t;
a constraint of a relationship among node active power, a node voltage amplitude and a node voltage phase angle:

$${p}_{b 1 , y}^{bus} ( t ) = {\sum }_{b 2} {G}_{b 1 , b 2}^{NET} {v}_{b 2 , y}^{amp} ( t ) - {\sum }_{b 2} {B}_{b 1 , b 2}^{NET *} {θ}_{b 2 , y} ( t ) ,$$

$$∀ b 1 , ∀ t ∈ {T}_{NOW}^{} , y = 1 , … , \vert {Y}_{n}^{} \vert ,$$

where p_{b1,y}^{bus}(t) is an active power input value of a node b1 in the scenario y and the time period t, G_{b1,b2}^{NET} is a real part of an element corresponding to a row b1 and a column b2 in a node admittance matrix Y^{NET}, v_{b2,y}^{amp}(t) is a node voltage of a node b2 in the scenario y and, the time period t, B_{b1,b2}^{NET*} is an imaginary part of the element corresponding to the row b1 and the column b2 in a node admittance matrix Y^{NET*}, θ_{b2,y}(t) is a node phase angle of the node b2 in the scenario y and the time period t, b1 and b2 are nodes, [symbol] _{T}^{NOW} is a set of scheduling time periods;
a constraint of a relationship among node reactive power, the node voltage amplitude and the node voltage phase angle:

$${q}_{b 1 , y}^{bus} ( t ) = - {\sum }_{b 2} {B}_{b 1 , b 2}^{NET} {v}_{b 2 , y}^{amp} ( t ) - {\sum }_{j ∈ N} {G}_{b 1 , b 2}^{NET} {θ}_{b 2 , y} ( t ) ,$$

$$∀ b 1 , ∀ t ∈ {T}_{NOW}^{} , y = 1 , … , \vert {Y}_{n}^{} \vert ,$$

where q_{b1,y}^{bus}(t) is a reactive power input value of the node b1 in the scenario y and the time period t, B_{b1,b2}^{NET} is an imaginary part of the element corresponding to the row b1 and the column b2 in a node admittance matrix Y^{NET};
a constraint of a relationship among active power flow of a transmission line, the voltage amplitude, and the voltage phase angle of a start node and an end node corresponding to the transmission line:

$${p}_{l , y}^{brch} ( t ) = {g}_{b 1 , b 2}^{NET} [ {v}_{b 1 , y}^{amp} ( t ) - {v}_{b 2 , y}^{amp} ( t ) ] - {u}_{b 1 , b 2}^{NET} [ {θ}_{b 1 , y} ( t ) - {θ}_{b 2 , y} ( t ) ] ,$$

$$∀ b 1 , l , ∀ t ∈ {T}_{NOW}^{} , y = 1 , … , \vert {Y}_{n}^{} \vert ,$$

where g_{b1,b2}^{NET} is conductance of the transmission line l, v_{b1,y}^{amp}(t) is node voltage of a node b1 in the scenario y and the time period t, θ_{b1,y}(t) is a node phase angle of the node b1 in the scenario y and the time period t;
a constraint of a relationship among reactive power flow of a transmission line, the voltage amplitude and the voltage phase angle of a start node and an end node corresponding to the transmission line:

$${q}_{l , y}^{brch} ( t ) = - {u}_{b 1 , b 2}^{NET} [ {v}_{b 1 , y}^{amp} ( t ) - {v}_{b 2 , y}^{amp} ( t ) ] - {g}_{b 1 , b 2}^{NET} [ {θ}_{b 1 , y} ( t ) - {θ}_{b 2 , y} ( t ) ] ,$$

$$∀ b 1 , l , ∀ t ∈ {T}_{NOW}^{} , y = 1 , … , \vert {Y}_{n}^{} \vert ; and$$

a constraint of an operating range of the node voltage phase angle:

$${θ}_{slack , y} ( t ) = 0 , {θ}_{b , y} ( t ) ∈ [ {\underline{θ}}_{b}^{angle} , {\overline{θ}}_{b}^{angle} ] , ∀ b , t , y = 1 , … , \vert {Y}_{n}^{} \vert ,$$

where θ_{slack,y}(t) is a phase angle of a slack node, θ_{b}^{angle} and θ̅_{b}^{angle} are a lower limit and an upper limit of the node phase angle of the node b in the scenario y and the time period t respectively.

Further, the step of generating multiple renewable energy power scenarios includes: for a renewable energy station j in a scheduling time period t, generating a random number R_{rand}^{j,t} in an interval [0,1] that obeys uniform distribution, then there must be an integer M₀ (1≤M₀≤M_{GMM}) so that the following formula is workable:

$${R}_{rand}^{j , t} ∈ [ {\sum }_{m = 0}^{{M}_{0} - 1} {ω}_{j , t , m} , {\sum }_{m = 0}^{{M}_{0}} {ω}_{j , t , m} ] ;$$

determining a renewable energy output probability distribution with a mean of P_{j,t,M}_{₀}^{μ} and a variance of P_{j,t,M}_{₀}^{σ}; sampling randomly from the renewable energy output probability distribution to obtain multiple renewable energy power scenarios; where renewable energy output probability distribution is represented by a Gaussian mixture model (GMM), M_{GMM} is a number of Gaussian components in the renewable energy output probability distribution, and ω_{j,t,m} is a weight coefficient of an m-th Gaussian component in the renewable energy output probability distribution.

Further, verifying the day-ahead scheduling results based on the power system prediction parameters and the multiple renewable energy power scenarios includes: for each renewable energy power scenario, constructing an intraday scheduling optimization model based on the day-ahead scheduling results and the power system prediction parameters; solving the intraday scheduling optimization model to obtain a multi-stage optimal solution of variables in the renewable energy power scenario; calculating a penalty cost corresponding to the day-ahead scheduling results based on the multi-stage optimal solution of the variables; and verifying the day-ahead scheduling results based on the penalty cost.

The method further includes: in case that the verifying the day-ahead scheduling results fails, updating a cutting plane set based on the penalty cost corresponding to the day-ahead scheduling results; optimizing the day-ahead scheduling results based on an updated cutting plane set, and verifying an optimized day-ahead scheduling results; and in case that verifying the optimized day-ahead scheduling results successes, outputting an optimized day-ahead scheduling results.

The present application further provides a day-ahead scheduling apparatus for a power system, including:
a power system prediction parameter obtaining module, used for obtaining power system prediction parameters in a to-be-scheduled time period, where the power system prediction parameters include thermal power unit parameters, renewable energy station parameters, load parameters, energy storage station (ESS) parameters, node parameters, a transmission line parameter and other power gird parameters;
a renewable energy power scenario generating module, use for constructing a day-ahead scheduling optimization model and generating multiple renewable energy power scenarios based on the power system prediction parameters;
a day-ahead scheduling optimization model solving module, used for solving the day-ahead scheduling optimization model to obtain day-ahead scheduling results;
day-ahead scheduling results verifying module, used for verifying the day-ahead scheduling results based on the power system prediction parameters and the multiple renewable energy power scenarios; and
day-ahead scheduling results outputting module, used for, in case that the verifying the day-ahead scheduling results successes, outputting the day-ahead scheduling results.

The present application further provides an electronic device, including a memory, a processor and a computer program stored in the memory and executable on the processor, where when the processor executes the program, the processor performs any of the above-mentioned day-ahead scheduling method for the power system.

The present application further provides a non-transitory computer-readable storage medium having a computer program stored thereon, where when executed by a processor, the computer program performs any of above-mentioned day-ahead scheduling method for the power system.

In the day-ahead scheduling method for the power system provided by the present application, by obtaining the power system prediction parameters in the to-be-scheduled time period; constructing the day-ahead scheduling optimization model and generating the multiple renewable energy power scenarios based on the power system prediction parameters; solving the day-ahead scheduling optimization model to obtain the day-ahead scheduling results; verifying the day-ahead scheduling results based on the power system prediction parameters and the multiple renewable energy power scenarios; and in case that the verifying the day-ahead scheduling results successes, the day-ahead scheduling results is output. In the method, the impact of the renewable energy station grid-connected proportion instructions on the renewable energy power scenarios is characterized by generating multiple renewable energy power scenarios, so that the decision-dependent uncertainty for renewable energy is considered in the day-ahead scheduling for power system, the voltage security for nodes in the power system is ensured by constructing the day-ahead scheduling optimization model, and the feasibility of intraday power grid operation is ensured by verifying the day-ahead scheduling result, which solves the problem that the decision-dependent uncertainty for renewable energy and the voltage security of power system are not fully considered in traditional power system scheduling modes, and the power system is safely and economically scheduled under the condition of voltage security.

### BRIEF DESCRIPTION OF DRAWINGS

In order to illustrate the solutions of the embodiments more clearly according to the present application and the related art, the accompanying drawings used in the description for the embodiments or the related art are briefly introduced below. It should be noted that the drawings in the following description are only some embodiments of the present application. For those of ordinary skill in the art, other drawings may be obtained according to these drawings without creative effort.

FIG. 1 is a schematic flowchart of a day-ahead scheduling method for a power system according to an embodiment of the present application;

FIG. 2 is a schematic overall flowchart of a day-ahead scheduling method for a power system according to an embodiment of the present application;

FIG. 3 is a schematic structural diagram of a day-ahead scheduling apparatus for a power system according to an embodiment of the present application; and

FIG. 4 is a schematic structural diagram of an electronic device according to an embodiment of the present application.

### DETAILED DESCRIPTION OF THE EMBODIMENTS

The solutions according to the present application are clearly described below in combination with the accompanying drawings in the embodiments of the present application. It should be noted that the described embodiments are some embodiments of the present application, rather than all the embodiments. Based on the embodiments of the present application, all other embodiments obtained by those of ordinary skill in the art without creative effort are within the scope of protection of the present application.

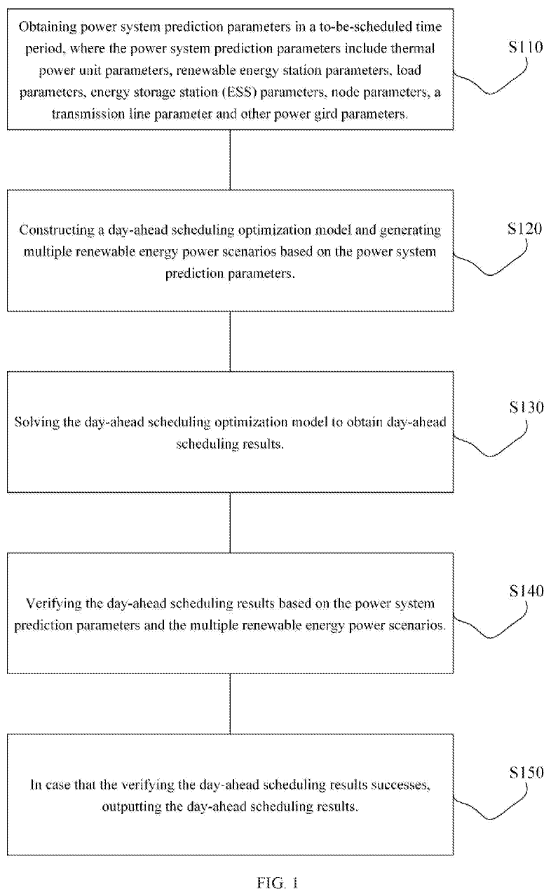

In order to solve the problem that the decision-dependent uncertainty for renewable energy and the voltage security of power system are not fully considered in traditional power system scheduling modes, the present application provides a day-ahead scheduling method for a power system in which the decision-dependent uncertainty for renewable energy and the voltage security of power system are considered. FIG. 1 shows a schematic flowchart of a day-ahead scheduling method for a power system according to an embodiment of the present application.

As shown in FIG. 1, the method includes the following steps.
S110: obtaining power system prediction parameters in a to-be-scheduled time period.

It should be noted that, when the power system day-ahead scheduling is performed, a data preparation operation needs to be performed first. In an embodiment, the power system prediction parameters in a to-be-scheduled time period are obtained, where the power system prediction parameters include thermal power unit parameters, renewable energy station parameters, load parameters, energy storage station (ESS) parameters, node parameters, a transmission line parameter and other power gird parameters.

The to-be-scheduled time period may be set based on an actual situation. For example, the to-be-scheduled time period is a next day, and the step S110 is to obtain the power system prediction parameters within the next day.

### 1) Thermal Power Unit Parameters.

An index of the thermal power unit is denoted as i, parameters of the thermal power unit include an active power output range [Pᵢ^{gen}, P̅ᵢ^{gen}] and a reactive output range [Qᵢ^{gen}, Q̅ᵢ^{gen}] of a thermal power unit i, an operating status Uᵢ(t) of the thermal power unit i in a to-be-scheduled time period t, a ramp up speed Rᵢ^{ramp,+}, a ramp down speed Rᵢ^{ramp,-}, an up regulation thermal spare capacity Rᵢ^{spare,+}, a down regulation thermal spare capacity Rᵢ^{spare,-}, a power output cᵢ^{g}, an regulation spare cost cᵢ^{spare} for regulating up and down per unit, a generation shift factor SF_{l,i}^{g} of the thermal power unit i with respect to the transmission line l, and a position correlation matrix BF_{b,i}^{g} of the thermal power unit i to the node b.

A set of the thermal power units i is denoted as [symbol] _{G}, and the number of the thermal power units is denoted as N_{G}.

### 2) Renewable Energy Station Parameters.

An index of the renewable energy station is denoted as j, parameters of the renewable energy station include a grid-connected proportion regulation range [Wⱼ^{pption}, W̅ⱼ^{pption}] of the renewable energy station, a unit cost cⱼ^{pption} of the renewable energy station grid-connected proportion regulation instruction, a unit power cut cost cⱼ^{recut} of the renewable energy station j, a generation shift factor SF_{l,j}^{renew} of the renewable energy station j with respect to the transmission line l, and a position correlation matrix BF_{b,j}^{renew} of the renewable energy station j with respect to the node b.

It should be noted that, in the present application, in case that Gaussian mixture model (GMM) is used to represent the probability distribution of the renewable energy output, an active GMM parameter set of the renewable energy station j in the time period t is:

Ω_{j,t}^{R}={ω_{j,t,m}^{R},P_{j,t,m}^{R,μ},P_{j,t,m}^{R,σ},m=1, . . . ,M_{GMM}},
where M_{GMM} is the number of Gaussian components, ω_{j,t,m}^{R} is a weight coefficient of an m-th Gaussian component (0<ω_{j,t,m}^{R}<1 and Σ_{m=1, . . . , M}_{_{GMM}}ω_{j,t,m}^{R}=1), P_{j,t,m}^{R,μ} is a mean value of the m-th Gaussian component, and P_{j,t,m}^{R,σ} is a variance of the m-th Gaussian component.

A set of the renewable energy stations j is denoted as [symbol] _{R}, and the number of the renewable energy stations j is denoted as N_{R}.

### 3) Load Parameters.

An index of the load is denoted as d, parameters of the load include an active power demand P_{d,t}^{D} and a reactive power demand Q_{d,t}^{D} of the load d in the time period t, a generation shift factor SF_{l,d} of the load d with respect to the transmission line l, a position correlation matrix BF_{b,d}^{D} of the load d with respect to the node b, a protocol capacity upper limit P̅_{d,t}^{dr} of demand side response power of the load d in the time period t, and a unit demand side response cost c_{d}^{ldcut} of the load d in the time period t.

A set of the loads is denoted as [symbol] _{D}, and the number of the loads is denoted as N_{D}.

### 4) ESS Parameters.

An index of the energy storage station is denoted as k, the parameters of the energy storage station include an upper limit of active charging and discharging power P̅ₖ^{ESS} of the energy storage station k, an upper limit of reactive charging and discharging power Q̅ₖ^{ESS} of the energy storage station k, an upper limit S̅ₖ^{ESS} of apparent power charging and discharging power of the energy storage station k, a capacity range [Eₖ^{ESS}, Ēₖ^{ESS}] of the energy storage station k, a charging efficiency ηₖ^{CH} of the energy storage station k, a discharging efficiency ηₖ^{DC} of the energy storage station k, an initial power value Et of the energy storage station k, a unit charging and discharging power cost cₖ^{ESS} of the energy storage station k, a generation shift factor SE_{l,k}^{ESS} of the energy storage k with respect to the line l, and a position correlation matrix BF_{b,k}^{ESS} of the energy storage k with respect to the node b.

A set of the energy storage is denoted as [symbol] _{ESS}, and the number of the energy storage is denoted as N_{ESS}.

### 5) Node Parameters.

An index of the node is denoted as b, parameters of the node include a voltage amplitude allowable variation range [V_{b}^{amp}, V̅_{b}^{amp}] of the node b, and a phase angle allowable variation range [θ_{b}^{angle}, θ̅_{b}^{angle}] of the node b.

A set of the nodes is denoted as [symbol] , and the number of the nodes is denoted as N_{B}.

In addition, the parameters of the node further include a node admittance matrix Y^{NET} of the power grid, a node admittance matrix Y_{NET*} without considering bypass capacitance, a real part G_{b1,b2}^{NET} of an element corresponding to a row b1 and a column b2 in the node admittance matrix Y^{NET}, an imaginary part B_{b1,b2}^{NET} of the element corresponding to the row b1 NET of an and the column b2 in the node admittance matrix Y^{NET}, and an imaginary part B_{b1,b2}^{NET*} of an element corresponding to a row b1 and a column b2 in the node admittance matrix Y^{NET*}.

### 6) Transmission Line Parameter.

An index of the transmission line is denoted as, a parameter of the transmission line includes a maximum power transmission capacity S̅ₗ^{L} of the transmission line l.

A set of the transmission line is denoted as £, and the number of the transmission line is denoted as N_{L}.

It should be note that, in case that two nodes corresponding to the transmission line l are b1 and b2, a conductance and a susceptance of the transmission I may be denoted as g_{b1,b2}^{NET} and u_{b1,b2}^{NET} respectively.

### 7) Other Power Grid Parameters.

The other power grid parameters include a unit scheduling cost c^{S} of active power balance emergency regulation resources and transmission line congestion emergency regulation resources, and a unit scheduling cost c^{SL} of reactive power balance emergency regulation resources and the transmission line congestion emergency regulation resources.
S120: constructing a day-ahead scheduling optimization model and generating multiple renewable energy power scenarios based on the power system prediction parameters.
S130: solving the day-ahead scheduling optimization model to obtain day-ahead scheduling results.

It should be noted that, on the basis of obtaining the power system prediction parameters in the to-be-scheduled time period in step S110, further, in step S120, the day-ahead scheduling optimization model is constructed based on the obtained power system prediction parameters, and multiple renewable energy power scenarios are generated based on the obtained power system prediction parameters, and in step S130, the day-ahead scheduling optimization model is solved to obtain the day-ahead scheduling result.

It should be noted that, in this embodiment, the process of the power system day-ahead scheduling involves a three-layer structure, including an upper level, a middle level and a lower level.

In the upper level, the day-ahead scheduling optimization model is constructed based on the power system prediction parameters, the constructed day-ahead scheduling optimization model is solved to obtain the day-ahead scheduling results.

In the middle level, multiple renewable energy power scenarios are generated based on the power system prediction parameters.

In the lower level, the day-ahead scheduling results transmitted from the upper level and the multiple renewable energy power scenarios transmitted from the middle level are received, and the day-ahead scheduling results are verified based on the power system prediction parameters and the multiple renewable power scenarios.

In step S120, the day-ahead scheduling optimization model is constructed base on the power system prediction parameters, where the day-ahead scheduling optimization model includes an objective function for power system day-ahead scheduling optimization problem and objective constraints corresponding to the objective function.

Accordingly, constructing the day-ahead scheduling optimization model includes constructing the objective function for power system day-ahead scheduling optimization problem and the objective constraints corresponding to the objective function, and there are multiple objective constraints (elaborated in the below embodiments).

Further, in step S130, multiple renewable energy power scenarios may be generated based on the power system prediction parameters. In an embodiment, since an active power GMM parameter set ω_{j,t}^{R} of the renewable energy station j (j=1, . . . , N_{R}) is: Ω_{j,t}^{R}={ω_{j,t,m}^{R},P_{j,t,m}^{R,μ},P_{j,t,m}^{R,σ},m=1, . . . , M}, denoting

$${ω}_{j , t , m}^{R} {\vert}_{m = 0} = 0 ,$$

the multiple renewable energy power scenarios h in a renewable energy power scenario set [symbol] _{RO}ⁿ may be generated by the following mode:
for the renewable energy station j in the time period t, a random number R_{rand}^{j,t} is generated in an interval [0,1] that obeys uniform distribution, then there must be an integer M₀ (1≤M₀≤M_{GMM}) so that the following formula is workable:

$${R}_{rand}^{j , t} ∈ [ {\sum }_{m = 0}^{{M}_{0} - 1} {ω}_{j , t , m} , {\sum }_{m = 0}^{{M}_{0}} {ω}_{j , t , m} ] , \qquad ( 1 )$$

a renewable energy output probability distribution with a mean value of P_{j,t,M}_{₀}^{μ} and a variance of P_{j,t,M}_{₀}^{σ} is determined, and a random sampling is performed from the renewable energy output probability distribution to obtain the multiple renewable energy power scenarios, an active power output of the renewable energy station j in the time period t may be obtained, and a renewable energy power scenario p_{j,t}^{renew,h} is generated.

The renewable energy output probability distribution is represented by a GMM, M_{GMM} is the number of Gaussian components in the renewable energy output probability distribution, and ω_{j,t,m} is a weight coefficient of an m-th Gaussian component in the renewable energy output probability distribution.

Further, the renewable energy power scenario p_{j,t}^{renew,h} (∀t∈ [symbol] , ∀j∈ [symbol] _{R}, ∀h=1, . . . , N_{RO}) of the scenario h in the renewable energy power scenario set N_{RO} may be obtained by traversing both the time period t and the renewable energy station j. The N_{RO} renewable energy scenarios P_{j,t}^{renew,h} (multiple renewable energy power scenarios) constitute the renewable energy power scenario set [symbol] _{RO}ⁿ.

h is an index of each of the renewable energy scenarios in the renewable energy power scenario set [symbol] _{RO}ⁿ.

On the basis of constructing the day-ahead scheduling optimization model in step S120, in step S130, the day-ahead scheduling optimization model is solved to obtain the day-ahead scheduling results.

The day-ahead scheduling results include a pre-output value \tilde{P}ᵢ^{g,n}(t) of the thermal power unit, an uphill spare tuning value \tilde{R}ᵢ^{g,up,n}(t) of the thermal power unit, a downhill spare tuning value \tilde{R}ᵢ^{g,dn,n}(t) of the thermal power unit, a renewable energy station grid-connected proportion instruction \tilde{W}ⱼ^{pption,n}(t), and a protocol capacity \tilde{P}_{d}^{dr,n}(t) of a demand side response.

It should be noted that, there is no strict logical sequence between the step of constructing the day-ahead scheduling optimization model in step S120 and the step of generating multiple renewable energy power scenarios, and neither there is a strict logical sequence between the step of generating multiple renewable energy power scenarios in step S130 and S120.
S140: verifying the day-ahead scheduling results based on the power system prediction parameters and the multiple renewable energy power scenarios.
S150: in case that verifying the day-ahead scheduling results successes, outputting the day-ahead scheduling results.

It should be noted that, in step S140, the lower level verifies, based on the power system prediction parameters in the to-be-scheduled time period obtained in step S110 and the multiple renewable energy power scenarios generated in step S120, the day-ahead scheduling results obtained by solving the day-ahead scheduling optimization model in step S130.

In case that the verifying the day-ahead scheduling results successes, the day-ahead scheduling results obtained in step S130 are regarded as final decision values of the power system and output; in case that the verifying the day-ahead scheduling results fails, a new round of iterating and updating is performed, which includes updating the day-ahead scheduling optimization model and repeatedly performing the steps from S120 to S140 until verifying the day-ahead scheduling results successes.

It should be noted that, the verifying the day-ahead scheduling results in this step is to correct day-ahead spare decision values of the power system, namely the day-ahead scheduling results, thereby ensuring the feasibility of day-ahead scheduling for the power system.

In this embodiment, by obtaining the power system prediction parameters in the to-be-scheduled time period; constructing the day-ahead scheduling optimization model and generating the multiple renewable energy power scenarios based on the power system prediction parameters; solving the day-ahead scheduling optimization model to obtain the day-ahead scheduling results; verifying the day-ahead scheduling results based on the power system prediction parameters and the multiple renewable energy power scenarios; the day-ahead scheduling results is output in case that the verifying the day-ahead scheduling results successes. In the method, the impact of the renewable energy station grid-connected proportion instructions on the renewable energy power scenarios is characterized by generating multiple renewable energy power scenarios, so that the decision-dependent uncertainty for renewable energy is taken into account in the day-ahead scheduling for power system, the voltage security for nodes in the power system is ensured by constructing the day-ahead scheduling optimization model, and the feasibility of intraday power grid operation is ensured by verifying the day-ahead scheduling result, which solves the problem that the decision-dependent uncertainty for renewable energy and the voltage security of power system are not fully considered in traditional power system scheduling modes, and the power system is safely and economically scheduled under the condition of voltage security.

On the basis of the above embodiment, the day-ahead scheduling optimization model is constructed based on the power system prediction parameters. In an embodiment, the day-ahead scheduling optimization model includes the objective function and the corresponding constraints, and constructing the day-ahead scheduling optimization model includes constructing the objective function for the power system day-ahead scheduling optimization problem and the objective constraints corresponding to the objective function.

The objective function (2) for the power system day-ahead scheduling optimization problem is as follows:

$$\{ {c}_{i}^{g} {p}_{i}^{g} ( t ) + {c}_{i}^{spare} [ {r}_{i}^{g , up} ( t ) + {r}_{i}^{g , dn} ( t ) ] \} + {min}_{\begin{matrix}{p}_{i}^{g} ( t ) , {r}_{i}^{g , up} ( t ) , {r}_{i}^{g , dn} ( t ) , {w}_{j}^{pption} ( t ) , {p}_{d}^{dr} ( t ) , \\ {p}_{j , y}^{re , cut} ( t ) , {p}_{j , y}^{re} ( t ) , {p}_{d , y}^{load} ( t ) , {p}_{d , y}^{load , cut} ( t ) , {p}_{i , y}^{gc} ( t ) , {q}_{i , y}^{gc} ( t ) , \\ {p}_{k , y}^{e , ch} ( t ) , {p}_{k , y}^{e , dc} ( t ) , {E}_{k , y} ( t ) , {q}_{k , y}^{e} ( t ) , {p}_{l , y}^{brch} ( t ) , {q}_{l , y}^{brch} ( t ) , \\ {s}_{y}^{1} ( t ) ∼ {s}_{y}^{4} ( t ) , {s}_{y}^{5} ( t ) ∼ {s}_{y}^{12} ( t ) , {v}_{b , y}^{amp} ( t ) , {p}_{b , y}^{bus} ( t ) , {q}_{b , y}^{bus} ( t ) , {θ}_{b , y} ( t ) , \\ {r}_{i , y}^{gc , use} ( t ) , {q}_{i , y}^{gc , use} ( t ) , {q}_{k , y}^{e , use} ( t ) , {η}_{y} , ∀ d , i , j , k , t , y = 1 , ... , \vert {Y}_{n}^{} \vert\end{matrix}} {\sum }_{t ∈ 𝒯} {\sum }_{j ∈ {R}_{}} {c}_{j}^{pption} \cdot \frac{{\overline{W}}_{j}^{pption} - {w}_{j}^{pption} ( t )}{{\overline{W}}_{j}^{pption} - {\underline{W}}_{j}^{pption}} + {\sum }_{t ∈ 𝒯} {\sum }_{d ∈ {D}_{}} {c}_{d}^{dr} {p}_{d}^{dr} ( t ) + {\sum }_{y ∈ {Y}_{n}^{}} {η}_{y} \qquad ( 2 )$$

$$s . t . objective constraints$$

where [symbol] is a set of scheduling time periods, [symbol] _{G} is a set of thermal power units, cᵢ^{g} is a cost per unit power output, pᵢ^{g}(t) is active pre-output power of a thermal power unit i in a time period t, cᵢ^{spare} is a regulation spare cost for regulating up and down per unit, rᵢ^{g,up}(t) is an uphill capacity of the thermal power unit i in the time period t, rᵢ^{g,dn}(t) is a downhill capacity of the thermal power unit i in the time period t, wⱼ^{pption}(t) is a renewable energy station grid-connected proportion of a renewable energy station j in the time period t, p_{d}^{dr}(t) is a protocol capacity of a demand side response of a load d in the time period t, p_{j,y}^{re,cut}(t) is a renewable energy power reduction value of the renewable energy station j in the time period t, p_{j,y}^{re}(t) is a renewable energy power grid-connected value of the renewable energy station j in the time period t, p_{d,y}^{load} (t) is a load power supply value of the load d in the time period t, p_{d,y}^{load,cut}(t) is a demand side response usage value of the load d in the time period t, p_{i,y}^{gc}(t) is unit real-time active power output of the thermal power unit i in the time period t, q_{i,y}^{gc}(t) is unit real-time reactive power output of the thermal power unit i in the time period t, p_{k,y}^{e,ch}(t) is active charging power of an energy storage station k in a scenario y and the time period t, p_{k,y}^{e,dc}(t) is active discharging power of the energy storage station k in the scenario y and the time period t, E_{k,y}(t) is stored energy of the energy storage station k in the scenario y and the time period t, q_{k,y}^{e}(t) is reactive power injected by the energy storage station to the power grid, p_{i,y}^{brch}(t) is reactive power flow of a transmission line l in the scenario y and the time period t, q_{l,y}^{brch}(t) is reactive power flow of the transmission line l in the scenario y and the time period t, s_{y}¹(t)˜s_{y}²(t) are slack variables of active power balance in the power system, s_{y}³ (t)˜s_{y}⁴(t) are slack variables of reactive power balance in the power system, s_{y}⁵(t)˜s_{y}¹²(t) are line capacity slack variables considering active power flow and reactive power flow, v_{b,y}^{amp} (t) is a node voltage of a node b in the scenario y and the time period t, p_{b,y}^{bus} (t) is an active power input value of the node b in the scenario y and the time period t, q_{b,y}^{bus}(t) is a reactive power input value of the node b in the scenario y and the time period t, θ_{b,y}(t) is a node phase angle value of the node b in the scenario y and the time period t, r_{i,y}^{gc,use}(t) is an auxiliary variable gc,use for obtaining the active power spare usage amount, q_{i,y}^{gc,use}(t) is an auxiliary variable for obtaining the reactive power spare usage amount, q_{k,y}^{e,use}(t) is an auxiliary variable for obtaining the reactive power spare usage amount of the energy storage station, [symbol] _{R} is a set of the renewable energy stations, cⱼ^{pption} is a unit cost of the renewable energy station grid-connected proportion regulation instruction, W̅ⱼ^{pption} is a upper limit of the renewable energy station grid-connected proportion of the renewable energy station j in the time period t, Wⱼ^{pption} is a lower limit of the renewable energy station grid-connected proportion of the renewable energy station j in the time period t, [symbol] _{D} is a set of the loads, c_{d}^{dr} is a cost of the demand side response per unit capacity, [symbol] _{Y}ⁿ is a set of typical renewable energy scenarios, η_{y} is a variable of power system operating cost in the scenario y, d is an index of the loads, i is a thermal power unit number, j is an index of the renewable energy stations, k is an index of the energy storage stations, t is a scheduling time point, y is an index of the renewable energy scenarios, l is an index of the transmission lines, and | [symbol] _{Y}ⁿ| is a number of elements included in the set of typical renewable energy scenarios [symbol] _{Y}ⁿ.

Further, there are multiple objective constraints in the objective function, including objective constraints (3) to (52), which are expanded as follows.

### 1) Constraints (3) to (5) of Active Pre-Output, Ramp Up, and Ramp Down of the Thermal Power Unit:

$${U}_{i} ( t ) {\underline{P}}_{i}^{gen} \leq {p}_{i}^{g} ( t ) \leq {U}_{i} ( t ) {\overline{P}}_{i}^{gen} , ∀ i ∈ {G}_{} , ∀ t ∈ \qquad ( 3 )$$

$${p}_{i}^{g} ( t + 1 ) - {p}_{i}^{g} ( t ) \leq {U}_{i} ( t ) {R}_{i}^{ramp , +} + [ 1 - {U}_{i} ( t ) ] \cdot {\overline{P}}_{i}^{gen} , ∀ i ∈ {G}_{} , ∀ t ∈ \qquad ( 4 )$$

$${p}_{i}^{g} ( t ) - {p}_{i}^{g} ( t + 1 ) \leq {U}_{i} ( t + 1 ) {R}_{i}^{ramp , -} + [ 1 - {U}_{i} ( t + 1 ) ] \cdot {\overline{P}}_{i}^{gen} , \\ ∀ i ∈ {G}_{} , ∀ t ∈ \qquad ( 5 )$$

where the variable pᵢ^{g}(t) represents the active pre-output power of the thermal power unit i in the time period t, the formulas (3) to (5) are constraints of the upper and lower limit of the pre-output of the thermal power unit, a constraint of the ramp up of the pre-output power of the thermal power unit, and a constraint of the ramp down of the pre-output power of the thermal power unit respectively.

### 2) Constraints (6) to (8) of Uphill Capacity and Downhill Capacity of the Thermal Power Unit:

$${U}_{i} ( t ) {\underline{P}}_{i}^{gen} + {r}_{i}^{g , dn} ( t ) \leq {p}_{i}^{g} ( t ) \leq {U}_{i} ( t ) {\overline{P}}_{i}^{gen} - {r}_{i}^{g , up} ( t ) , ∀ i ∈ {G}_{} , ∀ t ∈ , \qquad ( 6 )$$

$$0 \leq {r}_{i}^{g , up} ( t ) \leq {U}_{i} ( t ) {R}_{i}^{spare , +} , ∀ i ∈ {G}_{} , ∀ t ∈ , \qquad ( 7 )$$

$$0 \leq {r}_{i}^{g , dn} ( t ) \leq {U}_{i} ( t ) {R}_{i}^{spare , -} , ∀ i ∈ {G}_{} , ∀ t ∈ , \qquad ( 8 )$$

where the variables rᵢ^{g,up}(t) and rᵢ^{g,dn}(t) are the uphill capacity and the downhill capacity of the thermal power unit i in the time period t respectively, the formula (6) is a constraint of relationship between the uphill capacity, the downhill capacity, and the pre-output of the thermal power unit, the formula (7) is a physical constraint of the uphill capacity of the thermal power unit, and the formula (8) is a physical constraint of the downhill capacity of the thermal power unit.

### 3) A Constraint (9) of Renewable Energy Station Grid-Connected Proportion:

$${w}_{j}^{pption} ( t ) ∈ [ {\underline{W}}_{j}^{pption} , {\overline{W}}_{j}^{pption} ] , ∀ j ∈ {R}_{} , ∀ t ∈ , \qquad ( 9 )$$

where the variable wⱼ^{pption}(t) represents the renewable energy station grid-connected proportion of the renewable energy station j in the time period t, the formula (9) represents that decision on the variable wⱼ^{pption}(t) is made within the range from Wⱼ^{pption} to W̅ⱼ^{pption}.

### 4) A Constraint (10) of Protocol Capacity of Demand Side Response:

$$0 \leq {p}_{d}^{dr} ( t ) \leq {\overline{P}}_{d , t}^{dr} , ∀ d ∈ {D}_{} , ∀ t ∈ , \qquad ( 10 )$$

where the variable p_{d}^{dr}(t) is the protocol capacity of the demand side response of the load d in the time period t, P̅d,t^{dr} is an upper limit of the protocol capacity of the demand side response of the load d in the time period t.

### 5) Constraints (11) to (51) on Feasible Cut of the Day-Ahead Scheduling.

It should be noted that, some iteration parameters need to be used and n is denoted as the number of iterations in this embodiment, it is initialized that n=1.

In the process of an n-th iteration, the typical renewable energy scenario set used in the upper level is [symbol] _{Y}ⁿ, and the renewable energy power scenarios in [symbol] _{Y}ⁿ are denoted as P_{j,t}^{renew,y}

(j=1, . . . ,N_{R},t=1, . . . ,N_{T},y=1, . . . ,| [symbol] _{Y}ⁿ|),

where y is an index of the renewable energy scenarios, and | [symbol] _{Y}ⁿ| is the number of elements included in the set | [symbol] _{Y}ⁿ|.

In case that n=1, it is initialized that | [symbol] _{Y}ⁿ|=1, and the renewable energy output scenarios P_{j,t}^{renew,y}|_{y=1} (j=1, . . . , N_{R}, t=1, . . . , N_{T}) in [symbol] _{Y}ⁿ is set to be Σ_{m=1, . . . ,M}ω_{j,t,m}^{R}P_{j,t,m}^{R,μ}.

In the n-th iteration, for each of the renewable energy output scenario P_{j,t}^{renew,y} (j=1, . . . , N_{R}, t=1, . . . , N_{T}) in [symbol] _{Y}ⁿ, the constraints (11) to (51) need to be added.

$$0 \leq {p}_{j , y}^{re , cut} ( t ) \leq {F}_{j} [ {w}^{pption} ( t ) ] \cdot {P}_{j , t}^{renew , y} , \\ ∀ j ∈ {R}_{} , ∀ t ∈ , y = 1 , … , \vert {Y}_{n}^{} \vert \qquad ( 11 )$$

$${p}_{j , y}^{re} ( t ) + {p}_{j , y}^{re , cut} ( t ) = {F}_{j} [ {w}^{pption} ( t ) ] \cdot {P}_{j , t}^{renew , y} , \\ ∀ j ∈ {R}_{} , ∀ t ∈ , y = 1 , … , \vert {Y}_{n}^{} \vert \qquad ( 12 )$$

$${F}_{j} [ {w}^{pption} ( t ) ] = {\sum }_{e = 1}^{{N}_{R}} {a}_{j , e}^{pption} {w}_{e}^{pption} ( t ) + {b}_{j}^{pption} , ∀ j ∈ {R}_{} , ∀ t ∈ \qquad ( 13 )$$

where in constraint (11), the variables p_{j,y}^{re,cut}(t) and p_{j,y}^{re}(t) are the renewable energy power reduction value and the renewable energy power grid-connected value of the renewable energy station j in the scenario y and the time period t.

The constraints (11) and (12) are a constraint of an interval of the renewable energy power reduction value and a constraint of a relationship between the renewable energy power reduction value, the renewable energy power grid-connected value, and the renewable energy active power scenario, respectively.

In the constraints (11) to (13), the vector w^{pption}(t) is defined as w^{pption}(t)=[w₁^{pption}(t), . . . , wⱼ^{pption}(t), . . . ,

$${w}_{{N}_{R}}^{pption}$$

(t)], and the function Fⱼ[w^{pption}(t)] may be used to represent the different impacts of changes in grid-connected proportion instruction on the renewable energy active power output scenario of the renewable energy station j. The expression of the function Fⱼ[w^{pption}(t)] is shown in the constraint (13).

In the constraint (13), the coefficient a_{j,e}^{pption} represents the impact of changes in grid-connected proportion instruction of a renewable energy station e on the renewable energy active power scenario of the renewable energy station j, the coefficient bⱼ^{pption} is the constant term coefficient of the function Fⱼ[w^{pption}(t)].

$$0 \leq {p}_{d , y}^{load , cut} ( t ) \leq {p}_{d}^{dr} ( t ) , ∀ d ∈ {D}_{} , ∀ t ∈ , y = 1 , … , \vert {Y}_{n}^{} \vert \qquad ( 14 )$$

$${p}_{d , y}^{load} ( t ) + {p}_{d , y}^{load , cut} ( t ) = {P}_{d , t}^{D} , ∀ d ∈ {D}_{} , ∀ t ∈ , y = 1 , … , \vert {Y}_{n}^{} \vert \qquad ( 15 )$$

where the variables P_{d,y}^{load,cut}(t) and p_{d,y}^{load}(t) are demand side response usage value and load power supply value of the load d in the scenario y and the time period t respectively, the constraint (14) is a constraint on an interval of the demand side response usage value, and the constraint (15) is a constraint on a relationship between the load power supply, the demand side response usage value and the load prediction value.

$${U}_{i} ( t ) {\underline{P}}_{i}^{gen} \leq {p}_{i , y}^{gc} ( t ) \leq {U}_{i} ( t ) {\overline{P}}_{i}^{gen} , ∀ i ∈ {G}_{} , ∀ t ∈ , y = 1 , … , \vert {Y}_{n}^{} \vert \qquad ( 16 )$$

$${p}_{i}^{g} ( t ) - {r}_{i}^{g , dn} ( t ) \leq {p}_{i , y}^{gc} ( t ) \leq {p}_{i}^{g} ( t ) + {r}_{i}^{g , up} ( t ) , \\ ∀ i ∈ {G}_{} , ∀ t ∈ , y = 1 , … , \vert {Y}_{n}^{} \vert \qquad ( 17 )$$

$${p}_{i , y}^{gc} ( t + 1 ) - {p}_{i , y}^{gc} ( t ) \leq {U}_{i} ( t ) {R}_{i}^{ramp , +} + [ 1 - {U}_{i} ( t ) ] \cdot {\overline{P}}_{i}^{gen} , \\ ∀ i ∈ {G}_{} , ∀ t ∈ , y = 1 , … , \vert {Y}_{n}^{} \vert \qquad ( 18 )$$

$${p}_{i , y}^{gc} ( t ) - {p}_{i , y}^{gc} ( t + 1 ) \leq {U}_{i} ( t + 1 ) {R}_{i}^{ramp , -} + [ 1 - {U}_{i} ( t + 1 ) ] \cdot {\overline{P}}_{i}^{gen} , \\ ∀ i ∈ {G}_{} , ∀ t ∈ , y = 1 , … , \vert {Y}_{n}^{} \vert \qquad ( 19 )$$

where the variable p_{i,y}^{gc}(t) represents real-time active power output of the thermal power unit i in the time period t, the constraints (16) and (17) are constraints of an interval of the real-time active power output of the thermal power unit, and the constraints (18) and (19) are constraints of a ramp up speed and a ramp down speed of the real-time active power output of the thermal power unit.

$${U}_{i} ( t ) {\underline{Q}}_{i}^{gen} \leq {q}_{i , y}^{gc} ( t ) \leq {U}_{i} ( t ) {\overline{Q}}_{i}^{gen} , ∀ i ∈ {G}_{} , ∀ t ∈ , y = 1 , … , \vert {Y}_{n}^{} \vert \qquad ( 20 )$$

where the variable q_{i,y}^{gc}(t) represents the real-time reactive power output of the thermal power unit i in the period t, and the constraint (20) is a constraint of an interval of the real-time reactive power output of the thermal power unit.

$$0 \leq {p}_{k , y}^{e , ch} ( t ) \leq {\overline{P}}_{k}^{ess} , ∀ k ∈ {E}_{} , ∀ t ∈ , y = 1 , … , \vert {Y}_{n}^{} \vert \qquad ( 21 )$$

$$0 \leq {p}_{k , y}^{e , dc} ( t ) \leq {\overline{P}}_{k}^{ess} , ∀ k ∈ {E}_{} , ∀ t ∈ , y = 1 , … , \vert {Y}_{n}^{} \vert \qquad ( 22 )$$

$${E}_{k , y} ( t ) = {E}_{k , y} ( t - 1 ) + {η}_{k}^{ch} {p}_{k , y}^{e , ch} ( t ) - \frac{{p}_{k , y}^{e , dc} ( t )}{{η}_{k}^{dc}} , \\ ∀ k ∈ {E}_{} , ∀ t ∈ , y = 1 , … , \vert {Y}_{n}^{} \vert \qquad ( 23 )$$

$${\underline{E}}_{k}^{ess} ( t ) = {E}_{k , y} ( t ) \leq {\overline{E}}_{k}^{ess} , ∀ k ∈ {E}_{} , ∀ t ∈ , y = 1 , … , \vert {Y}_{n}^{} \vert \qquad ( 24 )$$

$${E}_{k , y} ( 0 ) = {E}_{k}^{init} , {E}_{k , y} ( {N}_{T} ) = {E}_{k}^{end} , ∀ k ∈ {E}_{} , y = 1 , … , \vert {Y}_{n}^{} \vert \qquad ( 25 )$$

$$- {\overline{Q}}_{k}^{ess} \leq {q}_{k , y}^{e} ( t ) \leq {\overline{Q}}_{k}^{ess} , ∀ k ∈ {E}_{} , ∀ t ∈ , y = 1 , … , \vert {Y}_{n}^{} \vert \qquad ( 26 )$$

$$- \sqrt{2} \cdot {\overline{S}}_{k}^{ess} \leq {p}_{k , y}^{e , ch} ( t ) - {p}_{k , y}^{e , dc} ( t ) + {q}_{k , y}^{e} ( t ) \leq \sqrt{2} \cdot {\overline{S}}_{k}^{ess} , \\ ∀ k ∈ {E}_{} , ∀ t ∈ , y = 1 , … , \vert {Y}_{n}^{} \vert \qquad ( 27 )$$

$$- \sqrt{2} \cdot {\overline{S}}_{k}^{ess} \leq {p}_{k , y}^{e , ch} ( t ) - {p}_{k , y}^{e , dc} ( t ) - {q}_{k , y}^{e} ( t ) \leq \sqrt{2} \cdot {\overline{S}}_{k}^{ess} , \\ ∀ k ∈ {E}_{} , ∀ t ∈ , y = 1 , … , \vert {Y}_{n}^{} \vert \qquad ( 28 )$$

where p_{k,y}^{e,ch}(t) represents active charging power of the energy storage station k in a scenario y and the time period t, p_{k,y}^{e,dc}(t) represents active discharging power of the energy storage station k in the scenario y and the time period t, E_{k,y}(t) represents the stored energy of the energy storage station k in the scenario y and the time period t, and q_{k,y}^{e}(t) represents the reactive power injected by the energy storage station to the power grid.

The constraints (21) and (22) are constraints of a charging power range of the energy storage station and a discharging power range of the energy storage station respectively, the constraint (23) is a constraint of a time period coupling of the stored energy of the energy storage station, the constraint (24) is a constraint of an upper limit and a lower limit of the stored energy of the energy storage station, the constraint (25) is a constraint of a value of the stored electric quantity energy at the beginning and end of a day for the energy storage station, the constraint (26) is a constraint of a range of the reactive power injected by the energy storage station k to the power grid in the scenario y and the time period t, and the constraints (27) and (28) are constraints of operating ranges of the active power and the reactive power of the energy storage station.

$${p}_{i , y}^{gc} ( t ) + {\sum }_{j ∈ {𝒩}_{R}} {p}_{j , y}^{re} ( t ) + {\sum }_{k ∈ {𝒩}_{E}} [ {p}_{k , y}^{e , ch} ( t ) - {p}_{k , y}^{e , dc} ( t ) ] + {s}_{y}^{1} ( t ) - {s}_{y}^{2} ( t ) = {\sum }_{d ∈ {N}_{D}} {p}_{d , y}^{load} ( t ) , ∀ t ∈ , y = 1 , … , \vert {𝒩}_{Y}^{n} \vert \qquad ( 29 )$$

$${q}_{i , y}^{gc} ( t ) + {\sum }_{k ∈ {𝒩}_{E}} {q}_{k , y}^{e} ( t ) + {s}_{y}^{3} ( t ) - {s}_{y}^{4} ( t ) = {\sum }_{d ∈ {N}_{D}} {Q}_{d , t}^{D} , \\ ∀ t ∈ , y = 1 , … , \vert {𝒩}_{Y}^{n} \vert \qquad ( 30 )$$

$$\vert {p}_{l , y}^{brch} ( t ) + {s}_{l , y}^{5} ( t ) - {s}_{l , y}^{6} ( t ) \vert \leq {\overline{S}}_{l}^{L} , ∀ t ∈ , y = 1 , … , \vert {𝒩}_{Y}^{n} \vert , ∀ l ∈ ℒ \qquad ( 31 )$$

$$\vert {q}_{l , y}^{brch} ( t ) + {s}_{l , y}^{7} ( t ) - {s}_{l , y}^{8} ( t ) \vert \leq {\overline{S}}_{l}^{L} , ∀ t ∈ , y = 1 , … , \vert {𝒩}_{Y}^{n} \vert , ∀ l ∈ ℒ \qquad ( 32 )$$

$$\vert {p}_{l , y}^{brch} ( t ) + {q}_{l , y}^{brch} ( t ) + {s}_{l , y}^{9} ( t ) - {s}_{l , y}^{10} ( t ) \vert \leq \sqrt{2} \cdot {\overline{S}}_{l}^{L} , \\ ∀ t ∈ , y = 1 , … , \vert {𝒩}_{Y}^{n} \vert , ∀ l ∈ ℒ \qquad ( 33 )$$

$$\vert {p}_{l , y}^{brch} ( t ) - {q}_{l , y}^{brch} ( t ) + {s}_{l , y}^{11} ( t ) - {s}_{l , y}^{12} ( t ) \vert \leq \sqrt{2} \cdot {\overline{S}}_{l}^{L} , \\ ∀ t ∈ , y = 1 , … , \vert {𝒩}_{Y}^{n} \vert , ∀ l ∈ ℒ \qquad ( 34 )$$

$${s}_{y}^{1} ( t ) , {s}_{y}^{2} ( t ) , {s}_{y}^{3} ( t ) , {s}_{y}^{4} ( t ) \geq 0 , ∀ t ∈ , y = 1 , … , \vert {𝒩}_{Y}^{n} \vert \qquad ( 35 )$$

$${s}_{l , y}^{5} ( t ) , {s}_{l , y}^{6} ( t ) , {s}_{l , y}^{7} ( t ) , {s}_{l , y}^{8} ( t ) , {s}_{l , y}^{9} ( t ) , {s}_{l , y}^{10} ( t ) , {s}_{l , y}^{11} ( t ) , {s}_{l , y}^{12} ( t ) \geq 0 , \\ ∀ t ∈ , y = 1 , … , \vert {𝒩}_{Y}^{n} \vert , ∀ l ∈ ℒ \qquad ( 36 )$$

where the variables p_{l,y}^{brch}(t) and q_{l,y}^{brch}(t) represent the active power flow and the reactive power flow of the transmission line l in the scenario y and the time period t, the variables s_{y}¹(t) and s_{y}²(t) represent the slack variables of the active power balance in the power system, the variables s_{y}³(t) and s_{y}⁴(t) represent the slack variables of the reactive power balance in the power system, and the variables s_{y}⁵(t)˜s_{y}¹²(t) are the line capacity slack variables considering active power flow and reactive power flow.

Corresponding to the above variables, the constraints (29) and (30) are constraints of the active power balance in the power system and the reactive power balance in the power system respectively, the constraints (31) to (34) are capacity constraints of the transmission line considering active power flow and reactive power flow, and the constraints (35) to (36) are non-negative constraints of the slack variables.

$${\underline{V}}_{b}^{amp} \leq {v}_{b , y}^{amp} ( t ) \leq {\overline{V}}_{b}^{amp} , ∀ t ∈ , y = 1 , … , \vert {Y}_{n}^{} \vert , ∀ b ∈ \qquad ( 37 )$$

where the variable v_{b}^{amp}(t) is the node voltage of the node b in the scenario y and the time period t, and the constraint (37) is an amplitude constraint of the node voltage.

$${p}_{b , y}^{bus} ( t ) = - {BF}_{b , d}^{D} \cdot {p}_{d , y}^{load} ( t ) + {BF}_{b , i}^{G} \cdot {p}_{i , y}^{gc} ( t ) + {BF}_{b , f}^{R} \cdot {p}_{j , y}^{re} ( t ) + {BF}_{b , k}^{ESS} \cdot [ - {p}_{k , y}^{e , ch} ( t ) + {p}_{k , y}^{e , dc} ( t ) ] , \\ ∀ b , d , i , j , k , l , t , y = 1 , … , \vert {Y}_{n}^{} \vert \qquad ( 38 )$$

$${q}_{b , y}^{bus} ( t ) = - {BF}_{b , d}^{D} \cdot {Q}_{d , t}^{D} + {BF}_{b , i}^{G} \cdot {q}_{i , y}^{gc} ( t ) + {BF}_{b , k}^{ESS} \cdot {q}_{k , y}^{e} ( t ) , \\ ∀ b , d , i , j , k , l , t , y = 1 , … , \vert {Y}_{n}^{} \vert \qquad ( 39 )$$

$${p}_{b 1 , y}^{bus} ( t ) = {\sum }_{b 2} {G}_{b 1 , b 2}^{NET} {v}_{b 2 , y}^{amp} ( t ) - {\sum }_{b 2} {B}_{b 1 , b 2}^{NET *} {θ}_{b 2 , y} ( t ) , \\ ∀ b 1 , ∀ t ∈ {T}_{NOW}^{} , y = 1 , … , \vert {Y}_{n}^{} \vert \qquad ( 40 )$$

$${q}_{b 1 , y}^{bus} ( t ) = - {\sum }_{b 2} {B}_{b 1 , b 2}^{NET} {v}_{b 2 , y}^{amp} ( t ) - {\sum }_{j ∈ N} {G}_{b 1 , b 2}^{NET} {θ}_{b 2 , y} ( t ) , \\ ∀ b 1 , ∀ t ∈ {T}_{NOW}^{} , y = 1 , … , \vert {Y}_{n}^{} \vert \qquad ( 41 )$$

$${p}_{l , y}^{brch} ( t ) = {g}_{b 1 , b 2}^{NET} [ {v}_{b 1 , y}^{amp} ( t ) - {v}_{b 2 , y}^{amp} ( t ) ] - {u}_{b 1 , b 2}^{NET} [ {θ}_{b 1 , y} ( t ) - {θ}_{b 2 , y} ( t ) ] , \\ ∀ b 1 , l , ∀ t ∈ {T}_{NOW}^{} , y = 1 , … , \vert {Y}_{n}^{} \vert \qquad ( 42 )$$

$${q}_{l , y}^{brch} ( t ) = - {u}_{b 1 , b 2}^{NET} [ {v}_{b 1 , y}^{amp} ( t ) - {v}_{b 2 , y}^{amp} ( t ) ] - {g}_{b 1 , b 2}^{NET} [ {θ}_{b 1 , y} ( t ) - {θ}_{b 2 , y} ( t ) ] , \\ ∀ b 1 , l , ∀ t ∈ {T}_{NOW}^{} , y = 1 , … , \vert {Y}_{n}^{} \vert \qquad ( 43 )$$

$${θ}_{slack , y} ( t ) = 0 , {θ}_{b , y} ( t ) ∈ [ {\underline{θ}}_{b}^{angle} , {\overline{θ}}_{b}^{angle} ] , ∀ b , t , y = 1 , … , \vert {Y}_{n}^{} \vert \qquad ( 44 )$$

where p_{b,y}^{bus}(t) and q_{b,y}^{bus}(t) represent the active power input value and the reactive power input value of the node b in the scenario y and the time period t, θ_{b,y}(t) represents the node phase angle value of the node b in the scenario y and the time period t, and in θ_{b,y}(t), a phase angle of a slack node is represented by θ_{slack,y}(t).

The constraints (38) and (39) are constraints on the node active power and the node reactive power respectively, the constraint (40) is a constraint of a relationship between the node reactive power, the node voltage amplitude and the node voltage phase angle, the constraint (42) is a constraint of a relationship between the active power flow of the transmission line, the voltage amplitude of the starting and end nodes corresponding to the transmission line and the voltage phase angle of the starting and end nodes corresponding to the transmission line, the constraint (43) is a constraint of a relationship between the reactive power flow of the transmission line, the voltage amplitude of the starting and end nodes corresponding to the transmission line and the voltage phase angle of the starting and end nodes corresponding to the transmission line, and the constraint (44) is a constraint of an operation range of the node voltage phase angle.

The above formulas (37) to (44) are the voltage security constraints among the objective constraints. In an embodiment, a linear flow mode considering the power system active and reactive power flow is used to construct the voltage amplitude, the voltage phase angle and the constraint of the relationship between the active power and the reactive power of the power device, and the constraints of the voltage amplitude of node and the operation ranges of the voltage phase angle of the node are added, and through the day-ahead scheduling method for the power system according to the present embodiment, the security of the voltage amplitude and phase angle of the power system may be ensured.

Compared with the traditional optimization mode based on direct current (DC) power flow, this embodiment may better ensure the voltage security of the power system and satisfy the active power balance and reactive power balance of the power system simultaneously.

$${r}_{i , y}^{gc , use} ( t ) \geq {p}_{i , y}^{gc} ( t ) - {p}_{i}^{g} ( t ) , ∀ i ∈ {G}_{} , ∀ t ∈ , y = 1 , … , \vert {Y}_{n}^{} \vert \qquad ( 45 )$$

$${r}_{i , y}^{gc , use} ( t ) \geq {p}_{i , y}^{gc} ( t ) - {p}_{i}^{g} ( t ) , ∀ i ∈ {G}_{} , ∀ t ∈ , y = 1 , … , \vert {y}_{n}^{} \vert \qquad ( 46 )$$

$${q}_{i , y}^{gc , use} ( t ) \geq {q}_{i , y}^{gc} ( t ) , ∀ i ∈ {G}_{} , ∀ t ∈ , y = 1 , … , \vert {Y}_{n}^{} \vert \qquad ( 47 )$$

$${q}_{i , y}^{gc , use} ( t ) \geq - {q}_{i , y}^{gc} ( t ) , ∀ i ∈ {G}_{} , ∀ t ∈ , y = 1 , … , \vert {Y}_{n}^{} \vert \qquad ( 48 )$$

$${q}_{k , y}^{e , use} ( t ) \geq {q}_{k , y}^{e} ( t ) , ∀ i ∈ {G}_{} , ∀ t ∈ , y = 1 , … , \vert {y}_{n}^{} \vert \qquad ( 49 )$$

$${q}_{k , y}^{e , use} ( t ) \geq - {q}_{k , y}^{e} ( t ) , ∀ i ∈ {G}_{} , ∀ t ∈ , y = 1 , … , \vert {Y}_{n}^{} \vert \qquad ( 50 )$$

where the variables r_{i,y}^{gc,use}(t), q_{i,y}^{gc,use}(t) and q_{k,y}^{e,use}(t) are auxiliary variables for obtaining the active power spare usage amount, the reactive power usage amount and the reactive power usage amount of the energy storage station respectively.

The constraints (45) to (50) are constraints of auxiliary variables for calculating the active power spare usage amount, the reactive power spare usage amount, and the reactive power spare usage amount of the energy storage station for the thermal power unit.

$${η}_{y} = [ {c}_{i}^{g} {p}_{i , y}^{gc} ( t ) + {c}_{i}^{g} {q}_{i , y}^{gc , use} ( t ) + {c}_{i}^{spare} {r}_{i , y}^{gc , use} ( t ) ] + \qquad ( 51 )$$

$${\sum }_{t ∈ 𝒯} {\sum }_{j ∈ {𝒩}_{R}} {c}_{j}^{recut} {p}_{j , y}^{re , cut} ( t ) + {\sum }_{t ∈ 𝒯} {\sum }_{k ∈ {𝒩}_{E}} {c}_{k}^{ess} [ {p}_{k , y}^{e , ch} ( t ) +$$

$${p}_{k , y}^{e , dc} ( t ) + {q}_{k , y}^{e , use} ( t ) ] ++ {\sum }_{t ∈ 𝒯} {\sum }_{d ∈ {𝒩}_{D}} {c}_{d}^{dr} {p}_{d , y}^{load , cut} ( t ) +$$

$${\sum }_{t ∈ 𝒯} {c}^{S} [ {s}_{y}^{1} ( t ) + {s}_{y}^{2} ( t ) + {s}_{y}^{3} ( t ) + {s}_{y}^{4} ( t ) ] + {\sum }_{t ∈ 𝒯} {\sum }_{l ∈ {𝒩}_{L}} {c}^{SL} [ {s}_{l , y}^{5} ( t ) +$$

$${s}_{l , y}^{6} ( t ) + {s}_{l , y}^{7} ( t ) + {s}_{l , y}^{8} ( t ) + {s}_{l , y}^{9} ( t ) + {s}_{l , y}^{10} ( t ) + {s}_{l , y}^{11} ( t ) + {s}_{l , y}^{12} ( t ) ]$$

$$y = 1 , … , \vert {𝒩}_{Y}^{n} \vert$$

where the variable η_{y} represents the power system operation cost in the scenario y.

The constraint (51) is a constraint equation for the power system intraday operation.

### 6) Reserve Tuning Causality Cutting Plane Set Constraint (52).

In the successive iterations of this embodiment, the lower level feeds back/transmits and updates the cutting plane set [symbol] _{CUT}ⁿ(t) to the upper level, and the variables pᵢ^{g}(t), rᵢ^{g,up}(t), rᵢ^{g,dn}(t), wⱼ^{pption}(t) and p_{d}^{dr}(t) need to satisfy the constraint shown in formula (52):

$$\{ \begin{matrix}{p}_{1}^{g} ( t ) , … , {p}_{i}^{g} ( t ) , … , {p}_{{N}_{G}}^{g} ( t ) , \\ {r}_{1}^{g , up} ( t ) , … , {r}_{i}^{g , up} ( t ) , … , {r}_{{N}_{G}}^{g , up} ( t ) , \\ {r}_{1}^{g , dn} ( t ) , … , {r}_{i}^{g , dn} ( t ) , … , {r}_{{N}_{G}}^{g , dn} ( t ) , \\ {w}_{1}^{pption} ( t ) , … , {w}_{j}^{pption} ( t ) , … , {w}_{{N}_{R}}^{pption} ( t ) , \\ {p}_{1}^{dr} ( t ) , … , {p}_{d}^{dr} ( t ) , … , {p}_{{N}_{D}}^{dr} ( t ) , ∀ t ∈\end{matrix} \} ∈ {CUT}_{n}^{} , \qquad ( 52 )$$

in case that n=1, [symbol] _{CUT}ⁿ(t) represent all the feasible region of the above decision variables; in case that n≥2, the expression of [symbol] _{CUT}ⁿ(t) is referred to formula (107).

The above formulas (3) to (52) are the necessary objective constraints to solve the objective function.

It should be noted that, the objective function of the day-ahead optimization model is to minimize the thermal power unit pre-output power cost, the thermal power unit spare cost, the renewable energy grid-connected proportion instruction cost, the demand side response protocol cost and the scheduling cost.

In an embodiment, a preliminary expression of the objective function of the day-ahead optimization model is shown as formula (53).

$${\sum }_{t ∈ 𝒯} {\sum }_{i ∈ {G}_{}} \{ {c}_{i}^{g} {p}_{i}^{g} ( t ) + {c}_{i}^{spare} [ {r}_{i}^{g , up} ( t ) + {r}_{i}^{g , dn} ( t ) ] \} + \qquad ( 53 )$$

$${min}_{\begin{matrix}{p}_{i}^{g} ( t ) , {r}_{i}^{g , up} ( t ) , {r}_{i}^{g , dn} ( t ) , {w}_{j}^{pption} ( t ) , \\ {p}_{d}^{dr} ( t ) , {p}_{j , y}^{re , cut} ( t ) , {p}_{j , y}^{re} ( t ) , {p}_{d , y}^{load} ( t ) , \\ {p}_{d , y}^{load , cut} ( t ) , {p}_{i , y}^{gc} ( t ) , {q}_{i , y}^{gc} ( t ) , \\ {p}_{k , y}^{e , ch} ( t ) , {p}_{k , y}^{e , dc} ( t ) , {E}_{k , y} ( t ) , \\ {q}_{k , y}^{e} ( t ) , {p}_{l , y}^{brch} ( t ) , {q}_{l , y}^{brch} ( t ) , \\ {s}_{y}^{1} ( t ) \sim {s}_{y}^{4} ( t ) , {s}_{y}^{5} ( t ) \sim {s}_{y}^{12} ( t ) , \\ {v}_{b}^{amp} ( t ) , {p}_{b , y}^{bus} ( t ) , {q}_{b , y}^{bus} ( t ) , {θ}_{b , y} ( t ) , \\ {r}_{i , y}^{gc , use} ( t ) , {q}_{i , y}^{gc , use} ( t ) , {q}_{k , y}^{e , use} ( t ) , \\ {η}_{y} , ∀ d , i , j , k , t , y = 1 , … , \vert {Y}_{n}^{} \vert\end{matrix}} {\sum }_{t ∈ 𝒯} {\sum }_{j ∈ {R}_{}} {c}_{j}^{pption} \cdot \frac{{\overline{W}}_{j}^{pption} - {w}_{j}^{pption} ( t )}{{\overline{W}}_{j}^{pption} - {\underline{W}}_{j}^{pption}} +$$

$${\sum }_{t ∈ 𝒯} {\sum }_{d ∈ {D}_{}} {c}_{d}^{dr} {p}_{d}^{dr} ( t ) + \frac{1}{\vert {Y}_{n}^{} \vert} {\sum }_{y ∈ {Y}_{n}^{}} {η}_{y}$$

On the basis of formula (53), the above constraints (3) to (52) are added, the following objective function may be obtained.

$${min}_{\begin{matrix}{p}_{i}^{g} ( t ) , {r}_{i}^{g , up} ( t ) , {r}_{i}^{g , dn} ( t ) , {w}_{j}^{pption} ( t ) , {p}_{d}^{dr} ( t ) , \\ {p}_{j , y}^{re , cut} ( t ) , {p}_{j , y}^{re} ( t ) , {p}_{d , y}^{load} ( t ) , {p}_{d , y}^{load , cut} ( t ) , {p}_{i , y}^{gc} ( t ) , {q}_{i , y}^{gc} ( t ) , \\ {p}_{k , y}^{e , ch} ( t ) , {p}_{k , y}^{e , dc} ( t ) , {E}_{k , y} ( t ) , {q}_{k , y}^{e} ( t ) , {p}_{l , y}^{brch} ( t ) , {q}_{l , y}^{brch} ( t ) , \\ {s}_{y}^{1} ( t ) \sim {s}_{y}^{4} ( t ) , {s}_{y}^{5} ( t ) \sim {s}_{y}^{12} ( t ) , {v}_{b}^{amp} ( t ) , {p}_{b , y}^{bus} ( t ) , {q}_{b , y}^{bus} ( t ) , {θ}_{b , y} ( t ) , \\ {r}_{i , y}^{gc , use} ( t ) , {q}_{i , y}^{gc , use} ( t ) , {q}_{k , y}^{e , use} ( t ) , {η}_{y} , ∀ d , i , j , k , t , y = 1 , … , \vert {𝒩}_{Y}^{n} \vert\end{matrix}} {\sum }_{t ∈ 𝒯} {\sum }_{i ∈ {𝒩}_{G}} \{ {c}_{i}^{g} {p}_{i}^{g} ( t ) + {c}_{i}^{spare} [ {r}_{i}^{g , up} ( t ) + {r}_{i}^{g , dn} ( t ) ] \} + {\sum }_{t ∈ 𝒯} {\sum }_{j ∈ {𝒩}_{R}} {c}_{j}^{pption} \cdot \frac{{\overline{W}}_{j}^{pption} - {w}_{j}^{pption} ( t )}{{\overline{W}}_{j}^{pption} - {\underline{W}}_{j}^{pption}} {\sum }_{t ∈ 𝒯} {\sum }_{d ∈ {𝒩}_{D}} {c}_{d}^{dr} {p}_{d}^{dr} ( t ) + {\sum }_{y ∈ {𝒩}_{Y}^{n}} {η}_{y} \qquad ( 54 )$$

$$s . t . ( 3 ) \sim ( 52 )$$

Decision values of the variables pᵢ^{g}(t), rᵢ^{g,up}(t), rᵢ^{g,dn}(t), wⱼ^{pption}(t) and p_{d}^{dr}(t) are denoted as \tilde{P}ᵢ^{g,n}(t), \tilde{R}ᵢ^{g,up,n}(t), \tilde{R}ᵢ^{g,dn,n}(t), \tilde{W}ⱼ^{pption,n}(t) and \tilde{P}_{d}^{dr,n}(t) respectively.

A footnote n is an index of the iteration number.

Subsequently, the upper level transmits the day-ahead scheduling results, namely \tilde{P}ᵢ^{g,n}(t), \tilde{R}ᵢ^{g,up,n}(t), \tilde{R}ᵢ^{g,dn,n}(t), \tilde{W}ⱼ^{pption,n}(t) and \tilde{P}_{d}^{dr,n}(t) to the lower level, and the lower level verifies the day-ahead scheduling results.

In this embodiment, by constructing the objective function for power system day-ahead scheduling optimization problem and the objective constraints corresponding to the objective function based on the power system prediction parameters; solving the corresponding day-ahead scheduling optimization model to obtain the day-ahead scheduling results; verifying the day-ahead scheduling results based on the power system prediction parameters and the multiple renewable energy power scenarios; and in case that the verifying the day-ahead scheduling results successes, the day-ahead scheduling results is output. In the method, the impact of the renewable energy station grid-connected proportion instructions on the renewable energy power scenarios is characterized by generating multiple renewable energy power scenarios, so that the decision-dependent uncertainty for renewable energy is considered in the day-ahead scheduling for power system, the voltage security for nodes in the power system is ensured by constructing the day-ahead scheduling optimization model, and the feasibility of intraday power grid operation is ensured by verifying the day-ahead scheduling result, which solves the problem that the decision-dependent uncertainty for renewable energy and the voltage security of power system are not fully considered in traditional power system scheduling modes, and the power system is safely and economically scheduled under the condition of voltage security.

On the basis of the above embodiment, verifying the day-ahead scheduling results based on the power system prediction parameters and the multiple renewable energy power scenarios includes: for each renewable energy power scenario, constructing the intraday scheduling optimization model based on the day-ahead scheduling results and the power system prediction parameters; solving the intraday scheduling optimization model to obtain a multi-stage optimal solution of the variable in the renewable energy power scenario; calculating penalty cost corresponding to the day-ahead scheduling results based on the multi-stage optimal solution of the variable; and verifying the day-ahead scheduling results based on the penalty cost.

It should be noted that, after the upper level transmits \tilde{P}ᵢ^{g,n}(t), \tilde{R}gᵢ^{g,up,n}(t), \tilde{R}ᵢ^{g,dn,n} (t), \tilde{W}ⱼ^{pption}(t) and \tilde{P}_{d}^{dr,n}(t) to the lower level, and the middle level transmits the renewable energy power scenario set [symbol] _{RO}ⁿ to the lower level, a model of the intraday scheduling optimization problem for the power system may be constructed using a sequential evolution concept.

In the intraday scheduling for the power system, the scheduling center generally may only better obtain the renewable energy prediction active power output value in a limited time period. The number of time periods that may be predicted in the renewable energy scenario is denoted as ΔT, the power system may predict the renewable energy output value from t_{now} to t_{now}+ΔT within the time period t_{now}, and a time period set from t_{now} to t_{now}+ΔT is denoted as [symbol] _{T}^{NOW}.

Therefore, for the renewable energy power scenario P_{j,t}^{renew,z}(∀j∈ [symbol] _{R}, ∀t∈ [symbol] ) in the set [symbol] _{RO}ⁿ, observable renewable energy output values of the power system in the time period t_{now} includes P_{j,t}_{_{now}}^{renew,z}+εₜ_{_{now}}^{R}(0), P_{j,t}_{_{now}}^{renew,z}+εₜ_{_{now}}^{R}(1), . . . , P_{j,t}_{_{now}}_{+ΔT}^{renew,z}εₜ_{_{now}}^{R}(ΔT), where εₜ_{_{now}}^{R}(0), εₜ_{_{now}}^{R}(1) . . . , εₜ_{_{now}}^{R}(ΔT) represent random error values of prediction for 0, 1, . . . , ΔT time periods after the time period t_{now} respectively.

In an application process, generally the error value of εₜ_{_{now}}^{R}(0)=0, and εₜ_{_{now}}^{R}(1), . . . , εₜ_{_{now}}^{R}(ΔT) may be estimated based on historical data.

The intraday optimization problem for the power system is a multi-stage scheduling problem, that is, the decision variable in the time period t_{now} may be affected by the decision value in the time period t_{now}−1.

An actual output value of the thermal power unit in time period t_{now}−1 is denoted as \tilde{P}_{i,z}^{gc,n}(t_{now}−1), a state of charge value of the energy storage station is denoted as \tilde{E}_{k,z}ⁿ(t_{now}−1), constraints (55) to (94) need to be constructed for the spare scheduling problem in time period t_{now}, and objective functions (95) to (96) need to be constructed, so that the constructed intraday scheduling optimization model is obtained.

The constraints included in the intraday scheduling optimization model are shown in detail below.

### 1) Real-Time Power Output Constraints (55) to (58) of the Thermal Power Unit:

$${U}_{i} ( t ) {\underline{P}}_{i}^{gen} \leq {p}_{i , z}^{gc} ( t ) \leq {U}_{i} ( t ) {\overline{P}}_{i}^{gen} , ∀ i ∈ {𝒩}_{G} , ∀ t ∈ {𝒩}_{T}^{NOW} , z = 1 , … , {N}_{RO} , \qquad ( 55 )$$

$${\tilde{P}}_{i}^{g , n} ( t ) - {\tilde{R}}_{i}^{g , dn , n} ( t ) \leq {p}_{i , z}^{gc} ( t ) \leq {\tilde{P}}_{i}^{g , n} ( t ) + {\tilde{R}}_{i}^{g , up , n} ( t ) , ∀ i ∈ {𝒩}_{G} , ∀ t ∈ {𝒩}_{T}^{NOW} , z = 1 , … , {N}_{RO} , \qquad ( 56 )$$

$${p}_{i , z}^{gc} ( t + 1 ) - {p}_{i , z}^{gc} ( t ) \leq {U}_{i} ( t ) {R}_{i}^{ramp , +} + [ 1 - {U}_{i} ( t ) ] \cdot {\overline{P}}_{i}^{gen} , ∀ i ∈ {𝒩}_{G} , ∀ t ∈ {𝒩}_{T}^{NOW} , z = 1 , … , {N}_{RO} , \qquad ( 57 )$$

$${p}_{i , z}^{gc} ( t ) - {p}_{i , z}^{gc} ( t + 1 ) \leq {U}_{i} ( t + 1 ) {R}_{i}^{ramp , -} + [ 1 - {U}_{i} ( t + 1 ) ] \cdot {\overline{P}}_{i}^{gen} , ∀ i ∈ {𝒩}_{G} , ∀ t ∈ {𝒩}_{T}^{NOW} , z = 1 , … , {N}_{RO} , \qquad ( 58 )$$

where the variable p_{i,z}^{gc}(t) represents the active power of the thermal power unit i in the time period t, Uᵢ(t) is the node voltage of the thermal power unit i in an intraday time period t, Pᵢ^{gen} is a lower limit of the active power output of the thermal power unit i, P̅ᵢ^{gen} is an upper limit of the active power output of the thermal power unit i, Rᵢ^{ramp,+} is the ramp up speed of the thermal power unit i, and Rᵢ^{ramp,-} is the ramp down speed of the thermal power unit i.

The constraints (55) and (56) are constraints of intervals of the real-time power output of the thermal power unit, and constraints (57) and (58) are constraints of the ramp up and ramp down ratio of the real-time output of the thermal power unit.

### 2) Demand Side Response Usage Amount Constraints (59) to (60):

$$0 \leq {p}_{d , z}^{load , cut} ( t ) \leq {\tilde{P}}_{d}^{dr , n} ( t ) , ∀ d ∈ {𝒩}_{D} , ∀ t ∈ {𝒩}_{T}^{NOW} , z = 1 , … , {N}_{RO} , \qquad ( 59 )$$

$${p}_{d , z}^{load} ( t ) + {p}_{d , z}^{load , cut} ( t ) = {P}_{d , t}^{load} , ∀ d ∈ {𝒩}_{D} , ∀ t ∈ {𝒩}_{T}^{NOW} , z = 1 , … , {N}_{RO} , \qquad ( 60 )$$

where the variables p_{d,z}^{load,cut}(t) and p_{d,z}^{load}(t) are the demand side response usage value and the load power supply value of the load d in the time period t respectively.

The constraints (59) and (60) are a constraint of an interval of the demand side response scheduling value and a constraint of a relationship between the load power supply value, the demand side response usage value and the load prediction value respectively.

Renewable energy power reduction value and power grid-connected value constraints (61) to (62):

$$0 \leq {p}_{j , z}^{re , cut} ( t ) \leq {F}_{j} [ {\tilde{W}}_{j}^{pption , n} ( t ) ] \cdot [ {P}_{j , t}^{renew , z} + {ε}_{{t}_{now}}^{R} ( t - {t}_{now} ) ] , ∀ j ∈ {𝒩}_{R} , ∀ t ∈ {𝒩}_{T}^{NOW} , z = 1 , … , {N}_{RO} , \qquad ( 61 )$$

$${p}_{j , z}^{re} ( t ) + {p}_{j , z}^{re , cut} ( t ) = {F}_{j} [ {\tilde{W}}_{j}^{pption , n} ( t ) ] \cdot [ {P}_{j , t}^{renew , z} + {ε}_{{t}_{now}}^{R} ( t - {t}_{now} ) ] , ∀ j ∈ {𝒩}_{R} , ∀ t ∈ {𝒩}_{T}^{NOW} , z = 1 , … , {N}_{RO} , \qquad ( 62 )$$

where the variables p_{j,z}^{re,cut}(t) and p_{j,z}^{re}(t) are the renewable energy power reduction value and the power grid-connected value of the renewable energy station j in the time period t, εₜ_{_{now}}^{R}(t−t_{now}) is a prediction error of renewable energy power for the time period obtained by predicting in time period t_{now}, \tilde{W}ⱼ^{pption,n}(t) is a vector consist of \tilde{W}ⱼ^{pption,n}(t), and there is \tilde{W}ⱼ^{pption,n}(t)=[\tilde{W}₁^{pption,n}(t), . . . , \tilde{W}ⱼ^{pption,n}(t), . . . , \tilde{W}_{N}_{_{R}}^{pption,n}(t)].

The constraint (61) is a constraint of an interval of the renewable energy power reduction value, and the constraint (62) is a constraint of a relationship between the renewable energy power reduction value, the power grid-connected value and a renewable energy power generation scenario.

### 4) Reactive Power Constraint (63) of Thermal Power Unit:

$${U}_{i} ( t ) {\underline{Q}}_{i}^{gen} \leq {p}_{i , z}^{gc} ( t ) \leq {U}_{i} ( t ) {\overline{Q}}_{i}^{gen} , ∀ i ∈ {𝒩}_{G} , ∀ t ∈ 𝒯 , z = 1 , … , {N}_{RO} , \qquad ( 63 )$$

where the variable q_{i,z}^{gc}(t) represents the unit real-time reactive power output of the thermal power unit i in the time period t, Qᵢ^{gen} is a lower limit of the reactive power of the thermal power unit i, \tilde{Q}ᵢ^{gen} is an upper limit of the reactive power of the thermal power unit i.

The constraint (63) is a constraint of an interval of the unit real-time reactive power output.

### 5) Operation Constraints (64) to (71) of Energy Storage Station:

$$0 \leq {p}_{k , z}^{e , ch} ( t ) \leq {\overline{P}}_{k}^{ess} , ∀ k ∈ {𝒩}_{E} , ∀ t ∈ {𝒩}_{T}^{NOW} , z = 1 , … , {N}_{RO} \qquad ( 64 )$$

$$0 \leq {p}_{k , z}^{e , dc} ( t ) \leq {\overline{P}}_{k}^{ess} , ∀ k ∈ {𝒩}_{E} , ∀ t ∈ {𝒩}_{T}^{NOW} , z = 1 , … , {N}_{RO} \qquad ( 65 )$$

$${E}_{k , z} ( t ) = {E}_{k , z} ( t - 1 ) + {η}_{k}^{ch} {p}_{p , z}^{e , ch} ( t ) - \frac{{p}_{k , z}^{e , dc} ( t )}{{η}_{k}^{dc}} , ∀ k ∈ {𝒩}_{E} , ∀ t ∈ {𝒩}_{T}^{NOW} , z = 1 , … , {N}_{RO} \qquad ( 66 )$$

$${\underline{E}}_{k}^{ess} \leq {E}_{k , z} ( t ) \leq {\overline{E}}_{k}^{ess} , ∀ k ∈ {𝒩}_{E} , ∀ t ∈ {𝒩}_{T}^{NOW} , z = 1 , … , {N}_{RO} \qquad ( 67 )$$

$$- {\overline{Q}}_{k}^{ess} \leq {q}_{k , z}^{e} ( t ) \leq {\overline{Q}}_{k}^{ess} , ∀ k ∈ {𝒩}_{E} , ∀ t ∈ {𝒩}_{T}^{NOW} , z = 1 , … , {N}_{RO} \qquad ( 68 )$$

$$- \sqrt{2} \cdot {\overline{S}}_{k}^{ess} \leq {p}_{k , z}^{e , ch} ( t ) - {p}_{k , z}^{e , dc} ( t ) + {q}_{k , z}^{e} ( t ) \leq \sqrt{2} \cdot {\overline{S}}_{k}^{ess} , ∀ k ∈ {𝒩}_{E} , ∀ t ∈ {𝒩}_{T}^{NOW} , z = 1 , … , {N}_{RO} \qquad ( 69 )$$

$$- \sqrt{2} \cdot {\overline{S}}_{k}^{ess} \leq {p}_{k , z}^{e , ch} ( t ) - {p}_{k , z}^{e , dc} ( t ) + {q}_{k , z}^{e} ( t ) \leq \sqrt{2} \cdot {\overline{S}}_{k}^{ess} , ∀ k ∈ {𝒩}_{E} , ∀ t ∈ {𝒩}_{T}^{NOW} , z = 1 , … , {N}_{RO} \qquad ( 70 )$$

where p_{k,z}^{e,ch}(t) represents the charging power of the energy storage station k in the scenario z and the time period t, p_{k,z}^{e,dc}(t) represents the discharging power of the energy storage station k in the scenario z and the time period t, E_{k,z}(t) represents the stored energy of the energy storage station k in the scenario z and the time period t, q_{k,z}^{e}(t) represents the reactive power injected to the power grid by the energy storage station, \tilde{P}ₖ^{ess} is the upper limit of active charging and discharging power of the energy storage station k, Eₖ^{ess} and Ēₖ^{ess} are the capacity upper limit and capacity lower limit of the energy storage station k, Q̅ₖ^{ess} is the upper limit of reactive charging and discharging power of the energy storage station k, and S̅ₖ^{ess} is the upper limit of apparent power charging and discharging power of the energy storage station k.

The constraints (64) and (65) are constraints of ranges of charging power and discharging power of the energy storage station, the constraint (66) is a constraint of a time period coupling of the stored energy of the energy storage station, the constraint (67) is a constraint of the upper limit and lower limit of the stored energy, the constraint (68) is a constraint of a range of the reactive power injected to the power grid by the energy storage station k, and the constraints (69) and (70) are constraints of operation ranges of the active power and reactive power of the energy storage station.

It should be noted that, when scheduling time period t_{now}=1, it needs to set that \tilde{E}_{k,z}(0)=Eₖ^{init}. In a day-end scheduling time period, a numerical constraint of state of charge for the energy storage station needs to be considered, that is, when t_{now}+ΔT≥N_{T}, the constraint (71) needs to be considered:

$${E}_{k , z} ( {N}_{T} ) = {E}_{k}^{end} , ∀ k ∈ {𝒩}_{E} , z = 1 , … , {N}_{RO} \qquad ( 71 )$$

$$when$$

$${t}_{0} + Δ T \geq {N}_{T} ,$$

where the parameter Eₖ^{end} is a day-end energy value of the energy storage station k.

### 6) Power System Power Balance and Line Capacity Constraints (72) to (79):

$${\sum }_{i ∈ {𝒩}_{G}} {p}_{i , z}^{gc} ( t ) + {\sum }_{j ∈ {𝒩}_{R}} {p}_{j , z}^{re} ( t ) + {\sum }_{k ∈ {𝒩}_{E}} [ {p}_{k , z}^{e , ch} ( t ) - {p}_{k , z}^{e , dc} ( t ) ] + {s}_{z}^{1} ( t ) - {s}_{z}^{2} ( t ) = {\sum }_{d ∈ {N}_{D}} {p}_{d , z}^{load} ( t ) , ∀ t ∈ {𝒩}_{T}^{NOW} , z = 1 , … {N}_{RO} , \qquad ( 72 )$$

$${\sum }_{i ∈ {𝒩}_{G}} {q}_{i , z}^{gc} ( t ) + {\sum }_{k ∈ {𝒩}_{E}} {q}_{k , z}^{e} ( t ) + {s}_{z}^{3} ( t ) - {s}_{z}^{4} ( t ) = {\sum }_{d ∈ {N}_{D}} {Q}_{d , t}^{D} , ∀ t ∈ {𝒩}_{T}^{NOW} , z = 1 , … , {N}_{RO} , \qquad ( 73 )$$

$$\vert {p}_{l , z}^{brch} ( t ) + {s}_{l , z}^{5} ( t ) - {s}_{l , z}^{6} ( t ) \vert \leq {\overline{S}}_{l}^{L} , ∀ t ∈ {𝒩}_{T}^{NOW} , z = 1 , … , {N}_{RO} , ∀ l ∈ ℒ , \qquad ( 74 )$$

$$\vert {q}_{l , z}^{brch} ( t ) + {s}_{l , z}^{7} ( t ) - {s}_{l , z}^{8} ( t ) \vert \leq {\overline{S}}_{l}^{L} , ∀ t ∈ {𝒩}_{T}^{NOW} , z = 1 , … , {N}_{RO} , ∀ l ∈ ℒ , \qquad ( 75 )$$

$$\vert {p}_{l , z}^{brch} ( t ) + {q}_{l , z}^{brch} ( t ) - {s}_{l , z}^{9} ( t ) - {s}_{l , z}^{10} ( t ) \vert \leq \sqrt{2} \cdot {\overline{S}}_{l}^{L} , ∀ t ∈ {𝒩}_{T}^{NOW} , z = 1 , … , {N}_{RO} , ∀ l ∈ ℒ , \qquad ( 76 )$$

$$\vert {p}_{l , z}^{brch} ( t ) - {q}_{l , z}^{brch} ( t ) - {s}_{l , z}^{11} ( t ) - {s}_{l , z}^{12} ( t ) \vert \leq \sqrt{2} \cdot {\overline{S}}_{l}^{L} , ∀ t ∈ {𝒩}_{T}^{NOW} , z = 1 , … , {N}_{RO} , ∀ l ∈ ℒ , \qquad ( 77 )$$

$${s}_{z}^{1} ( t ) , {s}_{z}^{2} ( t ) , {s}_{z}^{3} ( t ) , {s}_{z}^{4} ( t ) \geq 0 , ∀ t ∈ {𝒩}_{T}^{NOW} , z = 1 , … , {N}_{RO} , \qquad ( 78 )$$

$${s}_{l , z}^{5} ( t ) , {s}_{l , z}^{6} ( t ) , {s}_{l , z}^{7} ( t ) , {s}_{l , z}^{8} ( t ) , {s}_{l , z}^{9} ( t ) , {s}_{l , z}^{10} ( t ) , {s}_{l , z}^{11} ( t ) , {s}_{l , z}^{12} ( t ) \geq 0 , ∀ t ∈ {𝒩}_{T}^{NOW} , z = 1 , … , {N}_{RO} , ∀ l ∈ ℒ \qquad ( 79 )$$

where the variables brch (t) and brch (t) represent the active power flow and the reactive power flow of the transmission line l in the scenario z and the time period t, Q_{d,t}^{D} is the reactive power demand of the load d in the time period t, the variables s_{z}¹(t) and s_{z}²(t) are slack variables of the active power balance in the power system, the variables s_{z}³(t) and s_{z}⁴(t) are slack variables of the reactive power balance in the power system, variables s_{z}⁵(t)˜s_{z}¹²(t) are line capacity slack variables considering active power flow and reactive power flow, and S̅ₗ^{L} is a maximum power transmission capacity of the transmission line l.

Corresponding to the above variables, the constraint (72) is a constraint of the active power balance in the power system, the constraint (73) is a constraint of the reactive power balance in the power system, the constraints (74) to (77) are constraints of line capacity considering active power flow and reactive power flow, the constraint (78) is a non-negative constraint of slack variables s_{z}¹(t), s_{z}²(t), s_{z}³(t) and s_{z}⁴(t), and the constraint (79) is a non-negative constraint of slack variables s_{z}⁵(t)˜s_{z}¹²(t).

$${\underline{V}}_{b}^{amp} \leq {v}_{b , z}^{amp} ( t ) \leq {\overline{V}}_{b}^{amp} , ∀ t ∈ {𝒩}_{T}^{NOW} , z = 1 , … , {N}_{RO} , ∀ b ∈ ℬ \qquad ( 80 )$$

where the variable v_{b}^{amp}(t) is the node voltage of the node b in the scenario z and the time period t.

The constraint (80) is an amplitude constraint of the node voltage.

$${p}_{b , z}^{bus} ( t ) = - {BF}_{b , d}^{D} \cdot {p}_{d , z}^{load} ( t ) + {BF}_{b , i}^{G} \cdot {p}_{i , z}^{gc} ( t ) + {BF}_{b , j}^{R} \cdot {p}_{j , z}^{re} ( t ) + {BF}_{b , k}^{ESS} \cdot [ - {p}_{k , z}^{e , ch} + {p}_{k , z}^{e , dc} ( t ) ] , ∀ b , d , i , j , k , l , ∀ t ∈ {𝒩}_{T}^{NOW} , z = 1 , … , {N}_{RO} \qquad ( 81 )$$

$${p}_{b , z}^{bus} ( t ) = - {BF}_{b , d}^{D} \cdot {Q}_{d , t}^{D} ( t ) + {BF}_{b , i}^{G} \cdot {p}_{i , z}^{gc} ( t ) + {BF}_{b , k}^{ESS} \cdot {q}_{k , z}^{e} ( t ) , ∀ b , d , i , j , k , l , ∀ t ∈ {𝒩}_{T}^{NOW} , z = 1 , … , {N}_{RO} \qquad ( 82 )$$

$${p}_{b 1 , z}^{bus} ( t ) = {\sum }_{b 2} {G}_{b 1 , b 2}^{NET} {v}_{b 2 , z}^{amp} ( t ) - {\sum }_{b 2} {B}_{b 1 , b 2}^{NET *} {θ}_{b 2 , z} ( t ) , ∀ b 1 , ∀ t ∈ {𝒩}_{T}^{NOW} , z = 1 , … , {N}_{RO} \qquad ( 83 )$$

$${q}_{b 1 , z}^{bus} ( t ) = - {\sum }_{b 2} {B}_{b 1 , b 2}^{NET} {v}_{b 2 , z}^{amp} ( t ) - {\sum }_{j ∈ N} {G}_{b 1 , b 2}^{NET} {θ}_{b 2 , z} ( t ) , ∀ b 1 , ∀ t ∈ {𝒩}_{T}^{NOW} , z = 1 , … , {N}_{RO} \qquad ( 84 )$$

$${p}_{l , z}^{brch} ( t ) = {g}_{b 1 , b 2}^{NET} [ {v}_{b 1 , z}^{amp} ( t ) - {v}_{b 2 , z}^{amp} ( t ) ] - {u}_{b 1 , b 2}^{NET} [ {θ}_{b 1 , z} ( t ) - {θ}_{b 2 , z} ( t ) ] , ∀ b 1 , ∀ t ∈ {𝒩}_{T}^{NOW} , z = 1 , … , {N}_{RO} \qquad ( 85 )$$

$${p}_{l , z}^{brch} ( t ) = {u}_{b 1 , b 2}^{NET} [ {v}_{b 1 , z}^{amp} ( t ) - {v}_{b 2 , z}^{amp} ( t ) ] - {g}_{b 1 , b 2}^{NET} [ {θ}_{b 1 , z} ( t ) - {θ}_{b 2 , z} ( t ) ] , ∀ b 1 , l , ∀ t ∈ {𝒩}_{T}^{NOW} , z = 1 , … , {N}_{RO} \qquad ( 86 )$$

$${θ}_{slack , z} ( t ) = 0 , {θ}_{b , z} ( t ) ∈ [ {\underline{θ}}_{b}^{angle} , {\overline{θ}}_{b}^{angle} ] , ∀ b 1 , ∀ t ∈ {𝒩}_{T}^{NOW} , z = 1 , … , {N}_{RO} \qquad ( 87 )$$

where p_{b,z}^{bus}(t) and q_{b,z}^{bus}(t) represent the active power input value and the reactive power input value of the node b in the scenario z and the time period t, θ_{b,z}(t) represent the node phase angle value of the node b in the scenario z and the time period t, and in θ_{b,z}(t), a phase angle variable balancing the node is represented by θ_{slack,z}(t).

The constraints (81) and (82) are constraints of the node active power and the node reactive power respectively, the constraint (83) is a constraint of a relationship between the node active power input value, the node voltage amplitude and the node voltage phase angle, the constraint (84) is a constraint of a relationship between the node reactive power, the node voltage amplitude and the node voltage phase angle, the constraint (85) is a constraint of a relationship between the active power flow of the transmission line, the voltage amplitude of the starting and end nodes corresponding to the transmission line and the voltage phase angle of the starting and end nodes corresponding to the transmission line, the constraint (86) is a constraint on a relationship between the reactive power flow of the transmission line, the voltage amplitude of the starting and end nodes corresponding to the transmission line and the voltage phase angle of the starting and end nodes corresponding to the transmission line, and the constraint (87) is a constraint on an operation range of the node voltage phase angle.

$${r}_{i , z}^{gc , use} ( t ) \geq {p}_{i , z}^{gc} ( t ) - {p}_{i}^{g} ( t ) , ∀ i ∈ {𝒩}_{G} , ∀ t ∈ {𝒩}_{T}^{NOW} , z = 1 , … , {N}_{RO} \qquad ( 88 )$$

$${r}_{i , z}^{gc , use} ( t ) \geq {p}_{i}^{g} ( t ) - {p}_{i , z}^{gc} ( t ) , ∀ i ∈ {𝒩}_{G} , ∀ t ∈ {𝒩}_{T}^{NOW} , z = 1 , … , {N}_{RO} \qquad ( 89 )$$

$${q}_{i , z}^{gc , use} ( t ) \geq {q}_{i , z}^{gc} ( t ) , ∀ i ∈ {𝒩}_{G} , ∀ t ∈ {𝒩}_{T}^{NOW} , z = 1 , … , {N}_{RO} \qquad ( 90 )$$

$${q}_{i , z}^{gc , use} ( t ) \geq - {q}_{i , z}^{gc} ( t ) , ∀ i ∈ {𝒩}_{G} , ∀ t ∈ {𝒩}_{T}^{NOW} , z = 1 , … , {N}_{RO} \qquad ( 91 )$$

$${q}_{k , z}^{e , use} ( t ) \geq {q}_{k , z}^{e} ( t ) , ∀ i ∈ {𝒩}_{G} , ∀ t ∈ {𝒩}_{T}^{NOW} , z = 1 , … , {N}_{RO} \qquad ( 92 )$$

$${q}_{k , z}^{e , use} ( t ) \geq - {q}_{k , z}^{e} ( t ) , ∀ i ∈ {𝒩}_{G} , ∀ t ∈ {𝒩}_{T}^{NOW} , z = 1 , … , {N}_{RO} \qquad ( 93 )$$

where the variables r_{i,z}^{gc,use}(t), q_{i,z}^{gc,use}(t) and q_{k,z}^{e,use}(t) are auxiliary variables for obtaining the active power spare usage amount, the reactive power usage amount and the reactive power usage amount of the energy storage station respectively.

The constraints (88) to (93) are constraints on auxiliary variables for calculating the active power spare usage amount, the reactive power usage amount, and the reactive power usage amount of the energy storage station for the thermal power unit.

$${η}_{z} = {\sum }_{t ∈ {𝒩}_{T}^{NOW}} {\sum }_{i ∈ {𝒩}_{G}} [ {c}_{i}^{g} {p}_{i , z}^{gc} ( t ) + {c}_{i}^{g} {q}_{i , z}^{gc , use} ( t ) + {c}_{i}^{spare} {r}_{i , z}^{gc , use} ( t ) ] + {\sum }_{t ∈ {𝒩}_{T}^{NOW}} {\sum }_{j ∈ {𝒩}_{R}} {c}_{j}^{recut} {p}_{j , z}^{re , cut} ( t ) + {\sum }_{t ∈ {𝒩}_{T}^{NOW}} {\sum }_{k ∈ {𝒩}_{E}} {c}_{k}^{ess} [ {p}_{k , z}^{e , ch} ( t ) + {p}_{k , z}^{e , dc} ( t ) + {q}_{k , z}^{e , use} ( t ) ] ++ {\sum }_{t ∈ {𝒩}_{T}^{NOW}} {\sum }_{d ∈ {𝒩}_{D}} {c}_{d}^{dr} {p}_{d , z}^{load , cut} ( t ) + {\sum }_{t ∈ {𝒩}_{T}^{NOW}} {c}^{S} [ {s}_{z}^{1} ( t ) + {s}_{z}^{2} ( t ) + {s}_{z}^{3} ( t ) + {s}_{z}^{4} ( t ) ] + {\sum }_{t ∈ {𝒩}_{T}^{NOW}} {\sum }_{l ∈ {𝒩}_{L}} {c}^{SL} [ {s}_{l , z}^{5} ( t ) + {s}_{l , z}^{6} ( t ) + {s}_{l , z}^{7} ( t ) + {s}_{l , z}^{8} ( t ) + {s}_{l , z}^{9} ( t ) + {s}_{l , z}^{10} ( t ) + {s}_{l , z}^{11} ( t ) + {s}_{l , z}^{12} ( t ) ] z = 1 , … , {N}_{RO} \qquad ( 94 )$$

where the variable η_{z} represents the power system operation cost in the scenario z.

The constraint (94) is a constraint equation for the power system intraday operation.

The above formulas (55) to (94) are the constraints for the intraday scheduling optimization model.

It should be noted that, the objective function of the intraday optimization time period t_{now} is to minimize the system operation cost from t_{now} to t_{now}+ΔT. In an embodiment, a preliminary expression of the objective function of the intraday scheduling optimization model is as follows.

$${{min}_{{p}_{j , z}^{re , cut} ( t ) , {p}_{j , z}^{re} ( t ) , {p}_{d , z}^{load} ( t ) , {p}_{d , z}^{load , cut} ( t ) ,}}_{{{{{p}_{i , z}^{gc} ( t ) , {q}_{i , z}^{gc} ( t ) , {p}_{k , z}^{e , ch} ( t ) , {p}_{k , z}^{e , dc} ( t ) , {E}_{k , z} ( t ) , {q}_{k , z}^{e} ( t ) ,}_{{p}_{l , z}^{brch} ( t ) , {q}_{l , z}^{brch} ( t ) , {s}_{z}^{1} ( t ) \sim {s}_{z}^{4} ( t ) , {s}_{z}^{5} ( t ) \sim {s}_{z}^{12} ( t ) ,}}_{{v}_{b , z}^{amp} ( t ) , {p}_{b , z}^{bus} ( t ) , {q}_{b , z}^{bus} ( t ) , {θ}_{b , z} ( t ) , {r}_{i , z}^{gc , use} ( t ) ,}}_{{q}_{i , z}^{gc , use} ( t ) , {q}_{k , z}^{e , use} ( t ) , {η}_{z} , ∀ d , i , j , k , ∀ t ∈ {𝒩}_{T}^{NOW} , z = 1 , … , {N}_{RO}}} \frac{1}{{N}_{RO}} {\sum }_{z = 1}^{{N}_{RO}} {η}_{z} \qquad ( 95 )$$

On the basis of formula (95), the above constraints (55) to (94) are added, an overall expression for the optimization problem of the lower level in the time period t_{now} is obtained, namely the objective function of the intraday scheduling optimization model.

$${{min}_{{p}_{j , z}^{re , cut} ( t ) , {p}_{j , z}^{re} ( t ) , {p}_{d , z}^{load} ( t ) , {p}_{d , z}^{load , cut} ( t ) ,}}_{{{{{p}_{i , z}^{gc} ( t ) , {q}_{i , z}^{gc} ( t ) , {p}_{k , z}^{e , ch} ( t ) , {p}_{k , z}^{e , dc} ( t ) , {E}_{k , z} ( t ) , {q}_{k , z}^{e} ( t ) ,}_{{p}_{l , z}^{brch} ( t ) , {q}_{l , z}^{brch} ( t ) , {s}_{z}^{1} ( t ) \sim {s}_{z}^{4} ( t ) , {s}_{z}^{5} ( t ) \sim {s}_{z}^{12} ( t ) ,}}_{{v}_{b , z}^{amp} ( t ) , {p}_{b , z}^{bus} ( t ) , {q}_{b , z}^{bus} ( t ) , {θ}_{b , z} ( t ) , {r}_{i , z}^{gc , use} ( t ) ,}}_{{q}_{i , z}^{gc , use} ( t ) , {q}_{k , z}^{e , use} ( t ) , {η}_{z} , ∀ d , i , j , k , ∀ t ∈ {𝒩}_{T}^{NOW} , z = 1 , … , {N}_{RO}}} \frac{1}{{N}_{RO}} {\sum }_{z = 1}^{{N}_{RO}} {η}_{z} \qquad ( 96 )$$

$$s . t . ( 55 ) \sim ( 94 )$$

It should be noted that, the meanings of some parameters in the intraday scheduling optimization model constraints (55) to (94) correspond to that of some parameters in the day-ahead scheduling optimization model constraints (3) to (52) each other, the intraday scheduling optimization model uses the letter “z” as a footnote, and the day-ahead scheduling optimization model uses the letter “y” as a footnote, so that the parameters in the constraints of both the intraday scheduling optimization model and the day-ahead scheduling optimization model can be distinguished. In case that the meaning of parameter misses in the former or the latter, the two may be referred to each other.

In the time period t_{now} of the intraday optimization problem, an optimization problem (96) may be constructed and solved to obtain a multi-stage optimal solution of each variable from time period t_{now} to t_{now}+ΔT.

In the intraday actual scheduling, the scheduling center needs to deploy decisions in the current time period for the power system, and the decisions in the subsequent time periods may be adjusted through further observations of uncertainty. Therefore, in the time period t_{now}, the scheduling center may deploy the optimal solution when t=t_{now} for the power system.

Through the above analysis, for all scheduling time period t_{now}=1, . . . , N_{T} in the power system intraday optimization problem, the optimization problem (96) is constructed and solved, and the optimal scheduling values of the current time period are recorded respectively, the multi-stage optimal solution of variables in the zth renewable energy scenario p_{j,t}^{renew,z} (∀j∈ [symbol] _{R}, ∀t∈ [symbol] ) may be obtained. In the multi-stage optimal solution, it may be denoted in the nth iteration that, the multi-stage optimal solution of the variables s_{z}¹(t)˜s_{z}⁴(t) are \tilde{S}_{z}^{1,n}(t)˜\tilde{S}_{z}^{4,n}(t), and the multi-stage optimal solution of the variables s_{l,z}⁵(t)˜s_{l,z}¹²(t) are \tilde{S}_{l,z}^{5,n}(t)˜\tilde{S}_{l,z}^{12,n}(t).

In the intraday optimization problem (96) in the time period t, explicit expressions containing constraints \tilde{P}ᵢ^{g,n}(t), \tilde{R}ᵢ^{g,up,n}(t), \tilde{R}ᵢ^{g,dn,n}(t), \tilde{W}ⱼ^{pption,n}(t) and \tilde{P}_{d}^{dr,n}(t) are shown in (97) to (103):

$${p}_{i , z}^{g c} ( t ) \leq {\tilde{P}}_{i}^{g , n} ( t ) + {\tilde{R}}_{i}^{g , up , n} ( t ) : {λ}_{i , z}^{1 , n} ( t ) \geq 0 , ∀ i ∈ {G}_{} , \qquad ( 97 )$$

$${p}_{i , z}^{g c} ( t ) \geq {\tilde{P}}_{i}^{g , n} ( t ) - {\tilde{R}}_{i}^{g , dn , n} ( t ) : {λ}_{i , z}^{2 , n} ( t ) \geq 0 , ∀ i ∈ {G}_{} , \qquad ( 98 )$$

$${r}_{i , z}^{gc , use} ( t ) \geq {p}_{i , z}^{gc} ( t ) - {\tilde{P}}_{i}^{g , n} ( t ) : {λ}_{i , z}^{3 , n} ( t ) \geq 0 , ∀ i ∈ {G}_{} , \qquad ( 99 )$$

$${r}_{i , z}^{gc , use} ( t ) \geq {\tilde{P}}_{i}^{g , n} ( t ) - {p}_{i , z}^{gc} ( t ) , {λ}_{i , z}^{4 , n} ( t ) \geq 0 , ∀ i ∈ {G}_{} , \qquad ( 100 )$$

$${p}_{d , z}^{load , cut} ( t ) \leq {\tilde{P}}_{d}^{dr , n} ( t ) , {λ}_{d , z}^{5 , n} ( t ) \geq 0 , ∀ d ∈ {D}_{} , \qquad ( 101 )$$

$${p}_{j , z}^{re} ( t ) + {p}_{j , z}^{re , cut} ( t ) = {F}_{j} [ {\tilde{W}}_{j}^{pption , n} ( t ) ] \cdot {P}_{j , t}^{renew , z} , {λ}_{j , z}^{6 , n} ( t ) \geq 0 , ∀ j ∈ {R}_{} , \qquad ( 102 )$$

$${F}_{j} [ {\tilde{W}}_{j}^{pption , n} ( t ) ] = {\sum }_{e = 1}^{{N}_{R}} {α}_{j , e}^{pption} {\tilde{W}}_{e}^{pption , n} ( t ) + {b}_{j}^{pption} , ∀ j ∈ {R}_{} , ∀ t ∈ , \qquad ( 103 )$$

where λ_{i,z}^{1,n}(t)˜λ_{i,z}^{4,n}(t), λ_{d,z}^{5,n}(t) and λ_{j,z}^{6,n}(t) are dual variables of constraints (97) to (103) respectively.

After the intraday optimization problem (95) is solved, the value of the dual variables λ_{i,z}^{1,n}(t)˜λi,z^{4,n}(t), λ_{d,z}^{5,n}(t) and λ_{j,z}^{6,n}(t) may be denoted as \tilde{Λ}_{i,z}^{1,n}(t)˜\tilde{Λ}_{i,z}^{4,n}(t), \tilde{Λ}_{d,z}^{5,n}(t) and \tilde{Λ}_{j,z}^{6,n}(t) (∀i, d, j, z, t, n).

Based on the above content, the day-ahead scheduling method for the power system provided by the embodiment further includes: in case that the verifying the day-ahead scheduling results fails, updating a cutting plane set based on the penalty cost corresponding to the day-ahead scheduling results; optimizing the day-ahead scheduling results based on an updated cutting plane set, and verifying an optimized day-ahead scheduling results; and in case that the verifying the optimized day-ahead scheduling results successes, outputting an optimized day-ahead scheduling results.

It should be noted that, the penalty cost of the scheduling center may be defined based on the optimal solution of the optimization problem (96): in the nth iteration, the penalty cost of the scheduling center in the scenario z and time period t may be defined as C_{z}^{punish,n}(t). An explicit expression of C_{z}^{punish,n}(t) is shown as formula (104):

$${C}_{z}^{punish , n} ( t ) = {c}^{S} [ {\tilde{S}}_{z}^{1 , n} ( t ) + {\tilde{S}}_{z}^{2 , n} ( t ) + {\tilde{S}}_{z}^{3 , n} ( t ) + {\tilde{S}}_{z}^{4 , n} ( t ) ] + {\sum }_{l ∈ {L}_{}} {c}^{SL} [ \begin{matrix}{\tilde{S}}_{l , z}^{5 , n} ( t ) + {\tilde{S}}_{l , z}^{6 , n} ( t ) + {\tilde{S}}_{l , z}^{7 , n} ( t ) + {\tilde{S}}_{l , z}^{8 , n} ( t ) + \\ {\tilde{S}}_{l , z}^{9 , n} ( t ) + {\tilde{S}}_{l , z}^{10 , n} ( t ) + {\tilde{S}}_{l , z}^{11 , n} ( t ) + {\tilde{S}}_{l , z}^{12 , n} ( t )\end{matrix} ] \qquad ( 104 )$$

$${C}_{z}^{punish , n} ( t ) = {c}^{S} [ {\tilde{S}}_{z}^{1 , n} ( t ) + {\tilde{S}}_{z}^{2 , n} ( t ) + {\tilde{S}}_{z}^{3 , n} ( t ) + {\tilde{S}}_{z}^{4 , n} ( t ) ] + {\sum }_{l ∈ {L}_{}} {c}^{SL} [ \begin{matrix}{\tilde{S}}_{l , z}^{5 , n} ( t ) + {\tilde{S}}_{l , z}^{6 , n} ( t ) + {\tilde{S}}_{l , z}^{7 , n} ( t ) + {\tilde{S}}_{l , z}^{8 , n} ( t ) + \\ {\tilde{S}}_{l , z}^{9 , n} ( t ) + {\tilde{S}}_{l , z}^{10 , n} ( t ) + {\tilde{S}}_{l , z}^{11 , n} ( t ) + {\tilde{S}}_{l , z}^{12 , n} ( t )\end{matrix} ]$$

for the scenario z in the set [symbol] _{RO}ⁿ, C_{z}^{punish,n}(t) (∀t∈ [symbol] ) may be obtained by calculating based on \tilde{S}_{z}^{1,n}(t)˜\tilde{S}_{z}^{4,n}(t) and \tilde{S}_{l,z}^{5,n}(t)˜\tilde{S}_{l,z}^{12,n}(t) (∀t∈ [symbol] );
in case that [symbol] C_{z}^{punish,n}(t)=0, it indicates that the calculation results \tilde{P}ᵢ^{g,n}(t), \tilde{R}ᵢ^{g,up,n}(t), \tilde{R}ᵢ^{g,dn,n}(t), \tilde{W}ⱼ^{pption,n}(t) and \tilde{P}_{d}^{dr,n}(t) of the upper level optimization problem (objective function) may ensure the feasibility of the scenario z. On the contrary, it indicates that the iteration result cannot ensure the feasibility of the scenario z.

In this embodiment, a convergence criterion (iteration termination criterion) is: a proportion of the number of the feasible scenarios in the lower level to the number N_{RO} of the middle level renewable energy scenarios is greater than a preset value δ_{threshold}.

In the nth iteration, the number of feasible renewable energy scenarios in the renewable energy scenario set [symbol] _{RO} is denoted as w_{feasible}ⁿ, in case that the formula (105) is workable, the iteration ends, and the current \tilde{P}ᵢ^{g,n}(t), \tilde{R}ᵢ^{g,up,n}(t), \tilde{R}ᵢ^{g,dn,n}(t), \tilde{W}ⱼ^{pption,n}(t) and \tilde{P}_{d}^{dr,n}(t) are output as the decision result of the present application.

The formula (105) is as follows:

$$\frac{{w}_{feasible}^{n}}{{N}_{RO}} \geq {δ}_{threshold} , \qquad ( 105 )$$

in case that the formula (105) does not be workable, the objective constraint (52) of the day-ahead scheduling optimization model is updated based on the decision values \tilde{S}_{z}^{1,n}(t)˜\tilde{S}_{z}^{4,n}(t) and \tilde{S}_{l,z}^{5,n}(t)˜\tilde{S}_{l,z}^{12,n}(t) (∀t∈ [symbol] ) of all scheduling infeasible scenarios in the set [symbol] _{RO}ⁿ, and the infeasible renewable energy scenarios in this iteration are added in [symbol] _{Y}ⁿ⁺¹, then let n=n+1 and proceed to the next round of iteration.

The update mode of the constraint (52) when the nth iteration ends is described below.

For the scenario z, in case that [symbol] C_{z}^{punish,n}(t)>0, a cutting plane constraint of the upper level variables pᵢ^{g}(t), rᵢ^{g,up}(t), rᵢ^{g,dn}(t), wⱼ^{pption}(t) and p_{d}^{dr}(t) is constructed as formula (106).

$${\sum }_{t ∈ 𝒯} {\sum }_{i ∈ {G}_{}} \{ \begin{matrix}[ - {\tilde{Λ}}_{i , z}^{1 , n} ( t ) + {\tilde{Λ}}_{i , z}^{2 , n} ( t ) - {\tilde{Λ}}_{i , z}^{3 , n} ( t ) + {\tilde{Λ}}_{i , z}^{4 , n} ( t ) ] \cdot \\ [ {p}_{i}^{g} ( t ) - {\tilde{P}}_{i}^{g , n} ( t ) ] + [ - {\tilde{Λ}}_{i , z}^{1 , n} ( t ) ] \cdot \\ [ {r}_{i}^{g , up} ( t ) - {\tilde{R}}_{i}^{g , up , n} ( t ) ] + [ - {\tilde{Λ}}_{i , z}^{2 , n} ( t ) ] \cdot \\ [ {r}_{i}^{g , dn} ( t ) - {\tilde{R}}_{i}^{g , dn , n} ( t ) ]\end{matrix} \} + {\sum }_{t ∈ 𝒯} {\sum }_{j ∈ {R}_{}} [ {\sum }_{e = 1}^{{N}_{R}} {\tilde{Λ}}_{e , z}^{6 , n} ( t ) \cdot {P}_{e , t}^{renew , z} \cdot \frac{\partial {F}_{e} [ {w}^{pption} ( t ) ]}{\partial {w}_{j}^{pption} ( t )} ] \cdot [ {w}_{j}^{pption} ( t ) - {\tilde{W}}_{j}^{pption , n} ( t ) ] + {\sum }_{t ∈ 𝒯} {\sum }_{d ∈ {D}_{}} [ - {\tilde{Λ}}_{d , z}^{5 , n} ( t ) ] \cdot [ {p}_{d}^{dr} ( t ) - {\tilde{P}}_{d}^{dr , n} ( t ) ] \leq - {\sum }_{t ∈ 𝒯} {C}_{z}^{punish , n} ( t ) \qquad ( 106 )$$

Then, the formula (106) is added to the cutting plane set [symbol] _{CUT}ⁿ. After the nth iteration, the expression of [symbol] _{CUT}ⁿ is shown as formula (107).

$${CUT}_{n}^{} = \{ \begin{matrix}\{ \begin{matrix}{p}_{1}^{g} ( t ) , … , {p}_{i}^{g} ( t ) , … , {p}_{{N}_{G}}^{g} ( t ) , \\ {r}_{1}^{g , up} ( t ) , … , {r}_{i}^{g , up} ( t ) , … , {r}_{{N}_{G}}^{g , up} ( t ) , \\ {r}_{1}^{g , dn} ( t ) , … , {r}_{i}^{g , dn} ( t ) , … , {r}_{{N}_{G}}^{g , dn} ( t ) , \\ {w}_{1}^{pption} ( t ) , … , {w}_{j}^{pption} ( t ) , … , {w}_{{N}_{R}}^{pption} ( t ) , \\ {p}_{1}^{dr} ( t ) , … , {p}_{d}^{dr} ( t ) , … , {p}_{{N}_{D}}^{dr} ( t ) , ∀ t ∈\end{matrix} \} \\ {\sum }_{t ∈ 𝒯} {\sum }_{i ∈ {G}_{}} \{ \begin{matrix}[ - {\tilde{Λ}}_{i , z}^{1 , {n}_{0}} ( t ) + {\tilde{Λ}}_{i , z}^{2 , {n}_{0}} ( t ) - {\tilde{Λ}}_{i , z}^{3 , {n}_{0}} ( t ) + {\tilde{Λ}}_{i , z}^{4 , {n}_{0}} ( t ) ] \cdot \\ [ {p}_{i}^{g} ( t ) - {\tilde{P}}_{i}^{g , {n}_{0}} ( t ) ] + [ - {\tilde{Λ}}_{i , z}^{1 , {n}_{0}} ( t ) ] \cdot \\ [ {r}_{i}^{g , up} ( t ) - {\tilde{R}}_{i}^{g , up , {n}_{0}} ( t ) ] + [ - {\tilde{Λ}}_{i , z}^{2 , {n}_{0}} ( t ) ] \cdot \\ [ {r}_{i}^{g , dn} ( t ) - {\tilde{R}}_{i}^{g , dn , {n}_{0}} ( t ) ]\end{matrix} \} + {\sum }_{t ∈ 𝒯} {\sum }_{j ∈ {R}_{}} [ {\sum }_{e = 1}^{{N}_{R}} {\tilde{Λ}}_{e , z}^{6 , {n}_{0}} ( t ) \cdot {P}_{e , t}^{renew , z} \cdot \frac{\partial {F}_{e} [ {w}^{pption} ( t ) ]}{\partial {w}_{j}^{pption} ( t )} ] \cdot [ {w}_{j}^{pption} ( t ) - {\tilde{W}}_{j}^{pption , {n}_{0}} ( t ) ] + {\sum }_{t ∈ 𝒯} {\sum }_{d ∈ {D}_{}} [ - {\tilde{Λ}}_{d , z}^{5 , {n}_{0}} ( t ) ] \cdot [ {p}_{d}^{dr} ( t ) - {\tilde{P}}_{d}^{dr , {n}_{0}} ( t ) ] \leq - {\sum }_{t ∈ 𝒯} {C}_{z}^{punish , {n}_{0}} ( t ) , if {\sum }_{t ∈ 𝒯} {C}_{z}^{punish , {n}_{0}} ( t ) > 0 , z = 1 , … , \vert {RO}_{{n}_{0}}^{} \vert , {n}_{0} = 1 , … , n\end{matrix} \} \qquad ( 107 )$$

where | [symbol] _{RO}ⁿ| is the number of elements in a set [symbol] _{RO}ⁿ^{₀}.

In this embodiment, for each renewable energy power scenario, by constructing the intraday scheduling optimization model based on the day-ahead scheduling results and the power system prediction parameters; solving the intraday scheduling optimization model and obtaining the multi-stage optimal solution of the variable in the renewable energy power scenario; calculating the penalty cost corresponding to the day-ahead scheduling results based on the multi-stage optimal solution of the variable; verifying the day-ahead scheduling results based on the penalty cost; in case that the verifying the day-ahead scheduling results fails, updating the cutting plane set based on the penalty cost corresponding to the day-ahead scheduling results; optimizing the day-ahead scheduling results based on the updated cutting plane set; verifying the optimized day-ahead scheduling results; and only in case that the verifying the optimized day-ahead scheduling results successes, the optimized day-ahead scheduling results are output. In the method, the impact of the renewable energy station grid-connected proportion instructions on the renewable energy power scenarios is characterized by generating multiple renewable energy power scenarios, so that the decision-dependent uncertainty for renewable energy is considered in the day-ahead scheduling for power system, the voltage security for nodes in the power system is ensured by constructing the day-ahead scheduling optimization model, and the feasibility of intraday power grid operation is ensured by verifying the day-ahead scheduling result, which solves the problem that the decision-dependent uncertainty for renewable energy and the voltage security of power system are not fully considered in traditional power system scheduling modes, and the power system is safely and economically scheduled under the condition of voltage security.

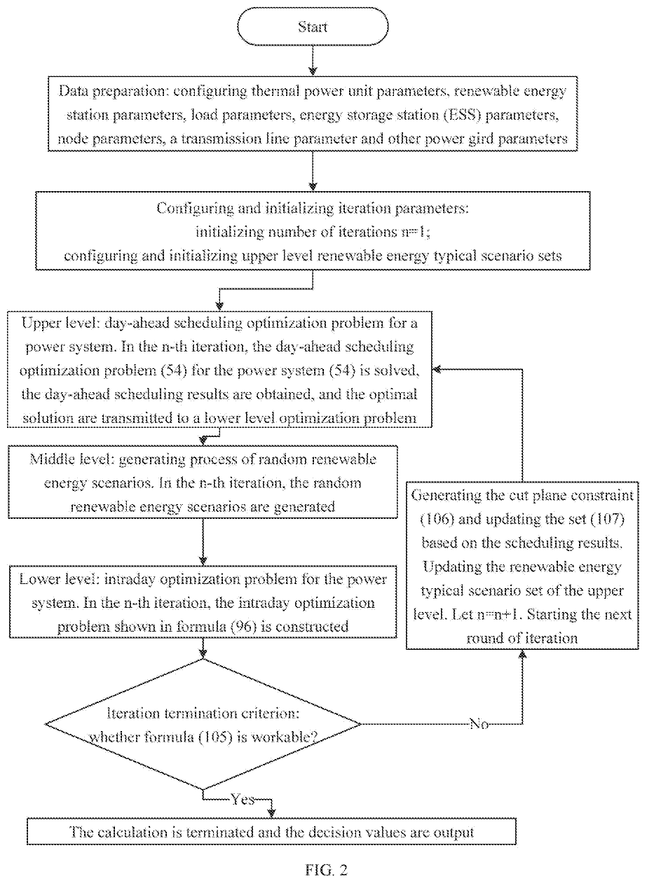

In addition, FIG. 2 shows a schematic overall flowchart of a day-ahead scheduling method for a power system according to an embodiment of the present application.

As shown in FIG. 2, firstly, a data preparation is performed, that is, the power system prediction parameters in a to-be-scheduled time period are obtained, where the power system prediction parameters include thermal power unit parameters, renewable energy station parameters, load parameters, energy storage station (ESS) parameters, node parameters, a transmission line parameter and other power gird parameters.

Secondly, iteration parameters are configured and an initialized. In an embodiment, the number of iterations is initialized as n=1, and upper level renewable energy typical scenario sets are configured and an initialized, that is, in the nth iteration, the renewable energy typical scenario sets used by the upper level are [symbol] _{Y}ⁿ and [symbol] _{Y}ⁿ, where renewable energy power scenarios are denoted as P_{j,t}^{renew,y} (j=1, . . . , N_{R}, t=1, . . . , N_{T}, y=1, . . . , | [symbol] _{Y}ⁿ|), y is an index of the renewable energy scenarios, and | [symbol] _{Y}ⁿ| is the number of elements included in the set [symbol] _{Y}ⁿ.

In case that n=1, it is initialized that | [symbol] _{Y}ⁿ|=1, and renewable energy output scenarios P_{j,t}^{renew,y}|_{y=1} (j=1, . . . , N_{R}, t=1, . . . , N_{T}) in [symbol] Y¹ are configured as Σ_{m=1, . . . ,M}ω_{j,t,m}^{R}P_{j,t,m}^{R,μ}.

Thirdly, an upper level is used for solving a day-ahead scheduling optimization problem for the power system, in the nth iteration, the day-ahead scheduling optimization problem (54) for the power system is solved to obtain the day-ahead scheduling results \tilde{P}ᵢ^{g,n}(t), \tilde{R}ᵢ^{g,up,n}(t), \tilde{R}ᵢ^{g,dn,n}(t), \tilde{W}ⱼ^{pption,n}(t) and \tilde{P}_{d}^{dr,n}(t), and the day-ahead scheduling results are transmitted to a lower level optimization problem.

Fourthly, a middle level is used for generating random renewable energy scenarios, that is, in the nth iteration, generating random renewable energy power scenarios.

Fifthly, a lower level is used for solving the intraday scheduling optimization problem in the power system, that is, in the nth iteration, constructing and solving the day-ahead scheduling optimization problem shown in formula (96).

Sixthly, whether the day-ahead scheduling results transmitted by the upper level are output is determining based on an iteration termination criterion, namely formula (105).

In case that formula (105), the calculation ends and the decision values are output directly, namely the day-ahead scheduling results \tilde{P}ᵢ^{g,n}(t), \tilde{R}ᵢ^{g,up,n}(t), \tilde{R}ᵢ^{g,dn,n}(t), \tilde{W}ⱼ^{pption,n}(t) and \tilde{P}_{d}^{dr,n}(t) transmitted by the upper later.

In case that the formula (105) does not be workable, the cutting plane constraint (106) is generated based on the day-ahead scheduling result, the set (107) is updated, the renewable energy typical scenario set of the upper level is updated, and let n=n+1 and proceed to the next round of iteration.

Based on the above description, the day-ahead scheduling method for the power system provided by the present application is summarized as follows.
(1) In terms of characterizing the uncertainty of renewable energy, the present application generates typical renewable energy power scenarios based on a probability distribution of renewable energy in each intraday time period to characterize the uncertainty of renewable energy. At the same time, the present application refers to an impact of the two instructions, namely the “renewable energy station grid-connected proportion” and “renewable energy station output upper limit”, issued by the scheduling center to the renewable energy station on the uncertainty of renewable energy in extremely high penetration of renewable energy power systems: the typical renewable energy power scenarios may change with changes in the two instructions, which may effectively reflect the changes in renewable energy power with decision instructions, and reflect the decision-dependent uncertainty of renewable energy output power.
(2) In terms of characterizing the voltage security of power system, different from the DC power flow model used in the prior art, a linear flow involving active and reactive power is incorporated into the day-ahead scheduling optimization model of the present application. By adding the linear flow and the voltage security constraints to the day-ahead scheduling model, the voltage security of nodes may be ensured while ensuring the balance of demand and supply of active and reactive power in the power system.
(3) In terms of causal modeling of power system decision process, the operational constraints of each device in sequentially disclosed renewable energy scenario, the active and reactive power balance of power system scheduling, and the limit of apparent power of line capacity are fully taken into account in the intraday multi-stage scheduling process for the power system of the present application, and a sequential evolution mode and a cutting plane construction mode are constructed to correct the power system day-ahead spare decision value to ensure the feasibility of intraday scheduling for the power system.

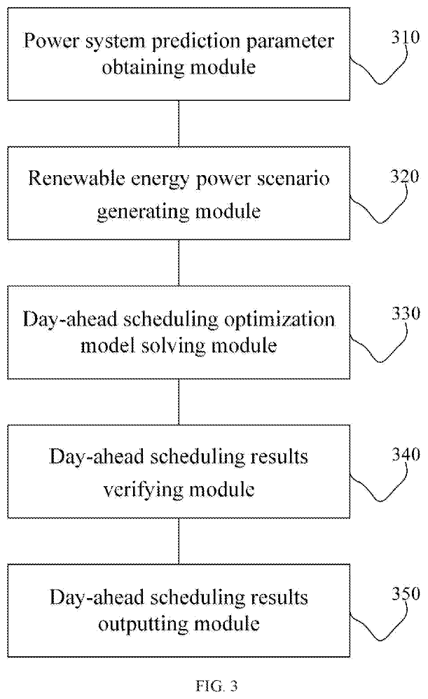

FIG. 3 shows a schematic structural diagram of a day-ahead scheduling apparatus ac for a power system cording to an embodiment of the present application.

As shown in FIG. 3, the apparatus includes:
a power system prediction parameter obtaining module 310, used for obtaining power system prediction parameters in a to-be-scheduled time period, where the power system prediction parameters include thermal power unit parameters, renewable energy station parameters, load parameters, energy storage station (ESS) parameters, node parameters, a transmission line parameter and other power gird parameters;
a renewable energy power scenario generating module 320, used for constructing a day-ahead scheduling optimization model and generating multiple renewable energy power scenarios based on the power system prediction parameters;
a day-ahead scheduling optimization model solving module 330, used for solving the day-ahead scheduling optimization model to obtain day-ahead scheduling results;
day-ahead scheduling results verifying module 340, used for verifying the day-ahead scheduling results based on the power system prediction parameters and the multiple renewable energy power scenarios; and
day-ahead scheduling results outputting module 350, used for, in case that the verifying the day-ahead scheduling results successes, outputting the day-ahead scheduling results.

In this embodiment, by obtaining the power system prediction parameters in the to-be-scheduled time period by the power system prediction parameter obtaining module 310; constructing the day-ahead scheduling optimization model and generating the multiple renewable energy power scenarios based on the power system prediction parameters by the renewable energy power scenario generating module 320; solving the day-ahead scheduling optimization model to obtain the day-ahead scheduling results by the day-ahead scheduling optimization model solving module 330; verifying the day-ahead scheduling results based on the power system prediction parameters and the multiple renewable energy power scenarios by the day-ahead scheduling results verifying module 340; and in case that the verifying the day-ahead scheduling results successes, the day-ahead scheduling results is output by the day-ahead scheduling results outputting module 350. In the apparatus, the impact of the renewable energy station grid-connected proportion instructions on the renewable energy power scenarios is characterized by generating multiple renewable energy power scenarios, so that the decision-dependent uncertainty for renewable energy is considered in the day-ahead scheduling for power system, the voltage security for nodes in the power system is ensured by constructing the day-ahead scheduling optimization model, and the feasibility of intraday power grid operation is ensured by verifying the day-ahead scheduling result, which solves the problem that the decision-dependent uncertainty for renewable energy and the voltage security of power system are not fully taken into account in traditional power system scheduling modes, and the power system is safely and economically scheduled under the condition of voltage security.

It should be noted that, the day-ahead scheduling apparatus for the power system provided by the present application and the above-described day-ahead scheduling method for the power system may be referred to each other, and the similar part is not repeated.

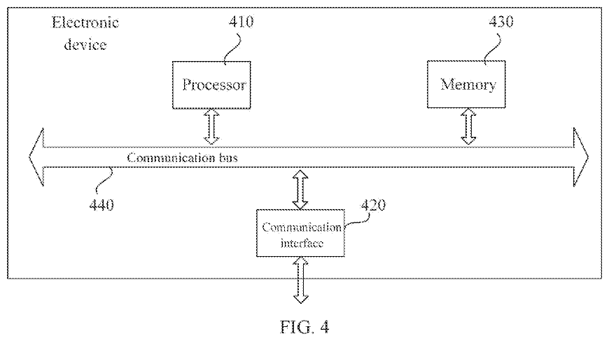

FIG. 4 shows a schematic structural diagram of an electronic device according to an embodiment of the present application. As shown in FIG. 4, the electronic device includes: a processor 410, a communication interface 420, a memory 430 and a communication bus 440, where the processor 410, the communication interface 420 and the memory 430 communicate with each other through the communication bus 440. The processor 410 may invoke the logical instructions in the memory 430 to perform the day-ahead scheduling method for the power system, the method includes:
obtaining power system prediction parameters in a to-be-scheduled time period, where the power system prediction parameters include thermal power unit parameters, renewable energy station parameters, load parameters, energy storage station (ESS) parameters, node parameters, a transmission line parameter and other power gird parameters;
constructing a day-ahead scheduling optimization model and generating multiple renewable energy power scenarios based on the power system prediction parameters;
solving the day-ahead scheduling optimization model to obtain day-ahead scheduling results;
verifying the day-ahead scheduling results based on the power system prediction parameters and the multiple renewable energy power scenarios; and
in case that the verifying the day-ahead scheduling results successes, outputting the day-ahead scheduling results.

In addition, if the logical instructions in storage 430 described above is implemented in the form of a software functional unit and sold or used as an independent product, it may be stored in a computer readable storage medium. Based on such understanding, the solutions of the present application in essence or a part of the solutions that contributes to the related art, or all or part of the solutions, may be embodied in the form of a software product, which is stored in a storage medium, including several instructions to cause a computer device (which may be a personal computer, server, or network device, etc.) to perform all or part of the steps of the methods described in the respective embodiments of the present application. The storage medium described above includes various media that may store program codes, such as USB flash disk, mobile hard disk, read-only memory (ROM), random access memory (RAM), magnetic disk, or optical disk.

The present application further provides a non-transitory computer readable storage medium storing a computer program that, when executed by a processor, causes the processor to perform the day-ahead scheduling method for the power system provided by the above embodiments, the method includes:
obtaining power system prediction parameters in a to-be-scheduled time period, where the power system prediction parameters include thermal power unit parameters, renewable energy station parameters, load parameters, energy storage station (ESS) parameters, node parameters, a transmission line parameter and other power gird parameters;
constructing a day-ahead scheduling optimization model and generating multiple renewable energy power scenarios based on the power system prediction parameters;
solving the day-ahead scheduling optimization model to obtain day-ahead scheduling results;
verifying the day-ahead scheduling results based on the power system prediction parameters and the multiple renewable energy power scenarios; and
in case that the verifying the day-ahead scheduling results successes, outputting the day-ahead scheduling results.

The apparatus embodiment described above is only schematic, the units described as separate components may or may not be physically separated, the components shown as units may or may not be physical units, that is, they may be located in one place, or may be distributed to multiple network units. Some or all of the modules may be selected according to actual needs to achieve the objective of this embodiment. Those of ordinary skill in the art may appreciate and implement without any creative effort.

Through the above description of the embodiments, those of ordinary skill in the art may clearly understand that each embodiment may be implemented by software plus a necessary general hardware platform, and of course, it can also be implemented by hardware. Based on such understanding, the solutions of the present application in essence or a part of the solutions that contributes to the related art, or all or part of the solutions, may be embodied in the form of a software product, which is stored in a computer readable storage medium, such as ROM/RAM, magnetic disk, optical disk, etc., including several instructions to cause a computer device (which may be a personal computer, server, or network device, etc.) to perform all or part of the steps of the methods described in the respective embodiments of the present application.

It should be noted that, the above embodiments are only used to illustrate the technical solution of the present application, but not to limit it; although the present application is described in detail with reference to the foregoing embodiments, it will be understood by those of ordinary skill in the art that they can still modify the technical solutions recorded in the foregoing embodiments, or make equivalent substitutions for some of the technical features; and these modifications or substitutions do not deviate from the essence of the corresponding technical solutions from the scope of the technical solutions of each embodiment of the present application.

What is claimed is:

1. A day-ahead scheduling method for a power system, comprising:
obtaining power system prediction parameters in a to-be-scheduled time period, wherein the power system prediction parameters comprise thermal power unit parameters, renewable energy station parameters, load parameters, energy storage station (ESS) parameters, node parameters, a transmission line parameter and other power gird parameters;
constructing a day-ahead scheduling optimization model and generating multiple renewable energy power scenarios based on the power system prediction parameters;
solving the day-ahead scheduling optimization model to obtain day-ahead scheduling results;
verifying the day-ahead scheduling results based on the power system prediction parameters and the multiple renewable energy power scenarios; and
in case that verifying the day-ahead scheduling results successes, outputting the day-ahead scheduling results.

2. The method of claim 1, wherein constructing the day-ahead scheduling optimization model based on the power system prediction parameters comprises:
constructing an objective function for power system day-ahead scheduling optimization problem and objective constraints corresponding to the objective function based on the power system prediction parameters.

3. The method of claim 2, wherein the objective function for power system day-ahead scheduling optimization problem is as follows:
$${\sum }_{t ∈ 𝒯} {\sum }_{i ∈ {G}_{}} \{ {c}_{i}^{g} {p}_{i}^{g} ( t ) + {c}_{i}^{spare} [ {r}_{i}^{g , up} ( t ) + {r}_{i}^{g , dn} ( t ) ] \} + {min}_{\begin{matrix}{p}_{i}^{g} ( t ) , {r}_{i}^{g , up} ( t ) , {r}_{i}^{g , dn} ( t ) , {w}_{j}^{pption} ( t ) , {p}_{d}^{dr} ( t ) , \\ {p}_{j , y}^{re , cut} ( t ) , {p}_{j , y}^{re} ( t ) , {p}_{d , y}^{load} ( t ) , {p}_{d , y}^{load , cut} ( t ) , {p}_{i , y}^{gc} ( t ) , {q}_{i , y}^{gc} ( t ) , \\ {p}_{k , y}^{e , ch} ( t ) , {p}_{k , y}^{e , dc} ( t ) , {E}_{k , y} ( t ) , {q}_{k , y}^{e} ( t ) , {p}_{l , y}^{brch} ( t ) , {q}_{l , y}^{brch} ( t ) , \\ {s}_{y}^{1} ( t ) \sim {s}_{y}^{4} ( t ) , {s}_{y}^{5} ( t ) \sim {s}_{y}^{12} ( t ) , {v}_{b , y}^{amp} ( t ) , {p}_{b , y}^{bus} ( t ) , {q}_{b , y}^{bus} ( t ) , {θ}_{b , y} ( t ) , \\ {r}_{i , y}^{gc , use} ( t ) , {q}_{i , y}^{gc , use} ( t ) , {q}_{k , y}^{e , use} ( t ) , {η}_{y} , ∀ d , i , j , k , t , y = 1 , … , \vert {Y}_{n}^{} \vert\end{matrix}} {\sum }_{t ∈ 𝒯} {\sum }_{i ∈ {R}_{}} {c}_{j}^{pption} \cdot \frac{{\overline{W}}_{j}^{pption} - {w}_{j}^{pption} ( t )}{{\overline{W}}_{j}^{pption} - {\underline{W}}_{j}^{pption}} + {\sum }_{t ∈ 𝒯} {\sum }_{d ∈ {D}_{}} {c}_{d}^{dr} {p}_{d}^{dr} ( t ) + {\sum }_{y ∈ {Y}_{n}^{}} {η}_{y}$$
$$s . t . objective constraints$$
wherein [symbol] is a set of scheduling time periods, [symbol] _{G} is a set of thermal power units, cᵢ^{g} is a cost per unit power output, pᵢ^{g}(t) is active pre-output power of a thermal power unit i in a time period t, cᵢ^{spare} is a regulation spare cost for regulating up and down per unit, rᵢ^{g,up}(t) is an uphill capacity of the thermal power unit i in the time period t, rᵢ^{g,dn}(t) is a downhill capacity of the thermal power unit i in the time period t, wⱼ^{pption}(t) is a renewable energy station grid-connected proportion of a renewable energy station j in the time period t, p_{d}^{dr}(t) is a protocol capacity of a demand side response of a load d in the time period t, p_{j,y}^{re,cut}(t) is a renewable energy power reduction value of the renewable energy station j in the time period t, p_{j,y}^{re}(t) is a renewable energy power grid-connected value of the renewable energy station j in the time period t, p_{d,y}^{load}(t) is a load power supply value of the load d in the time period t, p_{d,y}^{load,cut}(t) is a demand side response usage value of the load d in the time period t, p_{i,y}^{gc}(t) is unit real-time active power output of the thermal power unit i in the time period t, q_{i,y}^{gc}(t) is unit real-time reactive power output of the thermal power unit i in the time period t, p_{k,y}^{e,ch}(t) is active charging power of an energy storage station k in a scenario y and the time period t, p_{k,y}^{e,dc}(t) is active discharging power of the energy storage station k in the scenario y and the time period t, E_{k,y}(t) is stored energy of the energy storage station k in the scenario y and the time period t, q_{k,y}^{e}(t) is reactive power injected by the energy storage station to the power grid, p_{l,y}^{brch}(t) is active power flow of a transmission line l in the scenario y and the time period t, q_{l,y}^{brch}(t) is reactive power flow of the transmission line l in the scenario y and the time period t, s_{y}¹(t)˜s_{y}²(t) are slack variables of active power balance in the power system, s_{y}³(t)˜s_{y}⁴(t) are slack variables of reactive power balance in the power system, s_{y}⁵(t)˜s_{y}¹²(t) are line capacity slack variables considering active power flow and reactive power flow, v_{b,y}^{amp}(t) is a node voltage of a node b in the scenario y and the time period t, p_{b,y}^{bus}(t) is an active power input value of the node b in the scenario y and the time period t, q_{b,y}^{bus}(t) is a reactive power input value of the node b in the scenario y and the time period t, θ_{b,y}(t) is a node phase angle value of the node b in the scenario y and the time period t, r_{i,y}^{gc,use}(t) is an auxiliary variable for obtaining the active power spare usage amount, q_{i,y}^{gc,use}(t) is an auxiliary variable for obtaining the reactive power spare usage amount, q_{k,y}^{e,use}(t) is an auxiliary variable for obtaining the reactive power spare usage amount of the energy storage station, [symbol] _{R} is a set of the renewable energy stations, cⱼ^{pption} is a unit cost of the renewable energy station grid-connected proportion regulation instruction, W̅ⱼ^{pption} is a upper limit of the renewable energy station grid-connected proportion of the renewable energy station j in the time period t, Wⱼ^{pption} is a lower limit of the renewable energy station grid-connected proportion of the renewable energy station j in the time period t, [symbol] _{D} is a set of the loads, c_{d}^{dr} is a cost of the demand side response per unit capacity, [symbol] _{Y}ⁿ is a set of typical renewable energy scenarios, η_{y} is a variable of power system operating cost in the scenario y, d is an index of the loads, i is a thermal power unit number, j is an index of the renewable energy stations, k is an index of the energy storage stations, t is a scheduling time point, y is an index of the renewable energy scenarios, l is an index of the transmission lines, and | [symbol] _{Y}ⁿ| is a number of elements comprised in the set of typical renewable energy scenarios [symbol] _{Y}ⁿ.

4. The method of claim 3, wherein the objective constraints comprise voltage security constraints, and the voltage security constraints comprise:
a constraint of node voltage amplitude:
$${\underline{V}}_{b}^{amp} \leq {v}_{b , y}^{amp} ( t ) \leq {\overline{V}}_{b}^{amp} , ∀ t ∈ , y = 1 , … , \vert {Y}_{n}^{} \vert , ∀ b ∈ ,$$
wherein V_{b}^{amp} and V̅_{b}^{b} are a lower limit and an upper limit of the node b in the scenario y and the time period t respectively, b is an index of the nodes, and [symbol] is a set of the nodes;
a constraint of node active power:
$${p}_{b , y}^{bus} ( t ) = - {BF}_{b , d}^{D} \cdot {p}_{d , y}^{load} ( t ) + {BF}_{b , i}^{G} \cdot {p}_{i , y}^{gc} ( t ) + {BF}_{b , j}^{R} \cdot {p}_{j , y}^{re} ( t ) + {BF}_{b , k}^{ESS} \cdot [ - {p}_{k , y}^{e , ch} ( t ) + {p}_{k , y}^{e , dc} ( t ) ] , ∀ b , d , i , j , k , l , t , y = 1 , … , \vert {Y}_{n}^{} \vert ,$$
wherein BF_{b,d}^{D} is a position correlation matrix of the load d with respect to the node b, BF_{b,i}^{G} is a position correlation matrix of the thermal power unit i with respect to the node b, BF_{b,j}^{R} is a position correlation matrix of the renewable energy station j with respect to the node b, BF_{b,k}^{ESS} is a position correlation matrix of the energy storage station k with respect to the node b;
a constraint of node reactive power:
$${q}_{b , y}^{bus} ( t ) = - {BF}_{b , d}^{D} \cdot {Q}_{d , t}^{D} + {BF}_{b , i}^{G} \cdot {q}_{i , y}^{gc} ( t ) + {BF}_{b , k}^{ESS} \cdot {q}_{k , y}^{e} ( t ) , ∀ b , d , i , j , k , l , t , y = 1 , … , \vert {Y}_{n}^{} \vert ,$$
wherein Q_{d,t}^{D} is a reactive power demand of the load d in the time period t;
a constraint of a relationship among node active power, a node voltage amplitude and a node voltage phase angle:
$${p}_{b 1 , y}^{bus} ( t ) = {\sum }_{b 2} {G}_{b 1 , b 2}^{NET} {v}_{b 2 , y}^{amp} ( t ) - {\sum }_{b 2} {B}_{b 1 , b 2}^{NET *} {θ}_{b 2 , y} ( t ) , ∀ b 1 , ∀ t ∈ {T}_{NOW}^{} , y = 1 , … , \vert {Y}_{n}^{} \vert ,$$
wherein p_{b1,y}^{bus}(t) is an active power input value of a node b1 in the scenario y and the time period t, G_{b1,b2}^{NET} is a real part of an element corresponding to a row b1 and a column b2 in a node admittance matrix Y^{NET}, v_{b2,y}^{amp}(t) is a node voltage of a node b2 in the scenario y and the time period t, B_{b1,b2}^{NET*} is an imaginary part of the elements of corresponding to the row b1 and the column b2 in a node admittance matrix Y^{NET*}, θ_{b2,y}(t) is a node phase angle of the node b2 in the scenario y and the time period t, b1 and b2 are nodes, [symbol] _{T}^{NOW} is a set of scheduling time periods;
a constraint of a relationship among node reactive power, the node voltage amplitude and the node voltage phase angle:
$${q}_{b 1 , y}^{bus} ( t ) = - {\sum }_{b 2} {B}_{b 1 , b 2}^{NET} {v}_{b 2 , y}^{amp} ( t ) - {\sum }_{j ∈ N} {G}_{b 1 , b 2}^{NET} {θ}_{b 2 , y} ( t ) , ∀ b 1 , ∀ t ∈ {T}_{NOW}^{} , y = 1 , … , \vert {Y}_{n}^{} \vert ,$$
wherein q_{b1,y}^{bus}(t) is a reactive power input value of the node b1 in the scenario y and the time period t, B_{b1,b2}^{NET} is an imaginary part of the element corresponding to the row b1 and the column b2 in a node admittance matrix Y^{NET};
a constraint of a relationship among active power flow of a transmission line, the voltage amplitude, and the voltage phase angle of a start node and an end node corresponding to the transmission line:
$${p}_{l , y}^{brch} ( t ) = {g}_{b 1 , b 2}^{NET} [ {v}_{b 1 , y}^{amp} ( t ) - {v}_{b 2 , y}^{amp} ( t ) ] - {u}_{b 1 , b 2}^{NET} [ {θ}_{b 1 , y} ( t ) - {θ}_{b 2 , y} ( t ) ] , ∀ b 1 , l , ∀ t ∈ {T}_{NOW}^{} , y = 1 , … , \vert {Y}_{n}^{} \vert ;$$
wherein g_{b1,b2}^{NET} is conductance of the transmission line l, v_{b1,y}^{amp}(t) is node voltage of a node b1 in the scenario y and the time period t, θ_{b1,y}(t) is a node phase angle of the node b1 in the scenario y and the time period t;
a constraint of a relationship among reactive power flow of a transmission line, the voltage amplitude and the voltage phase angle of a start node and an end node corresponding to the transmission line:
$${q}_{l , y}^{brch} ( t ) = - {u}_{b 1 , b 2}^{NET} [ {v}_{b 1 , y}^{amp} ( t ) - {v}_{b 2 , y}^{amp} ( t ) ] - {g}_{b 1 , b 2}^{NET} [ {θ}_{b 1 , y} ( t ) - {θ}_{b 2 , y} ( t ) ] , ∀ b 1 , l , ∀ t ∈ {T}_{NOW}^{} , y = 1 , … , \vert {Y}_{n}^{} \vert ; and$$
a constraint of an operating range of the node voltage phase angle:
$${θ}_{slack , y} ( t ) = 0 , {θ}_{b , y} ( t ) ∈ [ {\underline{θ}}_{b}^{angle} , {\overline{θ}}_{b}^{angle} ] , ∀ b , t , y = 1 , … , \vert {Y}_{n}^{} \vert ;$$
wherein θ_{slack,y}(t) is a phase angle of a slack node, θ_{b}^{angle} and θ̅_{b}^{angle} are a lower limit and an upper limit of the node phase angle of the node b in the scenario y and the time period t respectively.

5. The method of claim 1, wherein the step of generating multiple renewable energy power scenarios comprises:
for a renewable energy station j in a scheduling time period t, generating a random number R_{rand}^{j,t} in an interval [0,1] that obeys uniform distribution, then there must be an integer M₀ (1≤M₀≤M_{GMM}) so that the following formula is workable:
$${R}_{rand}^{j , t} ∈ [ {\sum }_{m = 0}^{{M}_{0} - 1} {ω}_{j , t , m} , {\sum }_{m = 0}^{{M}_{0}} {ω}_{j , t , m} ] ;$$
determining a renewable energy output probability distribution with a mean of P_{j,t,M}_{₀}^{μ} and a variance of P_{j,t,M}_{₀}^{σ};
sampling randomly from the renewable energy output probability distribution to obtain the multiple renewable energy power scenarios;
wherein renewable energy output probability distribution is represented by a Gaussian mixture model (GMM), M_{GMM} is a number of Gaussian components in the renewable energy output probability distribution, and ω_{j,t,m} is a weight coefficient of an m-th Gaussian component in the renewable energy output probability distribution.

6. The method of any of claims 1 to 5, verifying the day-ahead scheduling results based on the power system prediction parameters and the multiple renewable energy power scenarios comprises:
for each renewable energy power scenario, constructing an intraday scheduling optimization model based on the day-ahead scheduling results and the power system prediction parameters;
solving the intraday scheduling optimization model to obtain a multi-stage optimal solution of variables in the renewable energy power scenario;
calculating a penalty cost corresponding to the day-ahead scheduling results based on the multi-stage optimal solution of the variables; and
verifying the day-ahead scheduling results based on the penalty cost.

7. The method of claim 6 further comprises:
in case that the verifying the day-ahead scheduling results fails, updating a cutting plane set based on the penalty cost corresponding to the day-ahead scheduling results;
optimizing the day-ahead scheduling results based on an updated cutting plane set, and verifying an optimized day-ahead scheduling results; and
in case that the verifying the optimized day-ahead scheduling results successes, outputting an optimized day-ahead scheduling results.

8. A day-ahead scheduling apparatus for a power system, comprising:
a power system prediction parameter obtaining module, used for obtaining power system prediction parameters in a to-be-scheduled time period, wherein the power system prediction parameters comprise thermal power unit parameters, renewable energy station parameters, load parameters, energy storage station (ESS) parameters, node parameters, a transmission line parameter and other power gird parameters;
a renewable energy power scenario generating module, used for constructing a day-ahead scheduling optimization model and generating multiple renewable energy power scenarios based on the power system prediction parameters;
a day-ahead scheduling optimization model solving module, used for solving the day-ahead scheduling optimization model to obtain day-ahead scheduling results;
day-ahead scheduling results verifying module, used for verifying the day-ahead scheduling results based on the power system prediction parameters and the multiple renewable energy power scenarios; and
day-ahead scheduling results outputting module, used for, in case that the verifying the day-ahead scheduling results successes, outputting the day-ahead scheduling results.

9. An electronic device, comprising a memory, a processor and a computer program stored in the memory and executable on the processor, wherein the computer program, when executed by the processor, causes the electronic device to perform the method of any of claims 1 to 7.

10. A non-transitory computer readable storage medium storing a computer program that, when executed by a processor, causes the processor to perform the method of any of claims 1 to 7.
